(19) United States
(12) Patent Application Publication
(10) Pub. No.: US 2026/0092151 A1
(43) Pub. Date: Apr. 2, 2026

(54) Compounds, their Preparation and Use

(71) Applicant: TPC Group LLC, Houston, TX (US)

(72) Inventors: Tim J. Coffy, Houston, TX (US); Wayne Ouellette, Missouri City, TX (US)

(21) Appl. No.: 18/931,902

(22) Filed: Oct. 30, 2024

Related U.S. Application Data
(63) Continuation-in-part of application No. 18/904,859, filed on Oct. 2, 2024.

(51) Int. Cl. C08G 81/02

(52) U.S. Cl. CPC C08G 81/025

(57) ABSTRACT

The invention relates to a polyisobutylene polyether alcohol amine compounds and compositions thereof. The invention also is directed to a new process for making the polyisobutylene polyether alcohol amine compound(s) by reacting a polyisobutylene epoxide with a specific polyetheramine, a protic solvent, a diluent, and optionally a catalyst. In addition, the invention further relates to the many uses of the polyisobutylene polyether alcohol amine compound(s) and composition(s) including but not limited to its use in lubricants, surfactants, emulsifiers, adhesives, resins, and the like.

### CROSS-REFERENCE TO RELATED PATENT APPLICATIONS

This continuation in part application is based on and claims priority to U.S. Non-Provisional application Ser. No. 18/904,859, of the same title, filed Oct. 2, 2024, and its disclosure incorporated by reference herein.

### FIELD OF THE INVENTION

The invention relates to new compounds, their preparation and use. In particular the new compounds are novel polyisobutylene compounds, more particularly a polyisobutylene polyether alcohol amine, more specifically a mono-polyisobutylene polyether alcohol amine, bis-polyisobutylene polyether alcohol amine, a tris-polyisobutylene polyether alcohol amine and a tetrakis-polyisobutylene polyether alcohol amine, and mixtures thereof. The invention also is directed to a new process for making these mono-, bis-, tris-, and tetrakis, polyisobutylene polyether alcohol amine compositions, and to its many uses in lubricants, surfactants, emulsifiers, resins, adhesives and the like.

### BACKGROUND OF THE INVENTION

Polyisobutylene (PIB) is well known in the art and produced typically by the polymerization of isobutylene in the presence of catalyst. PIB is a long chain molecule of various lengths of isobutylene molecules and has different number average molecular weight (Mn) and polydispersity index (PDI) that gives selective properties such as viscosity.

Conventional PIB compounds and compositions having primarily internal unsaturation (double bond) tend to be less reactive, primarily made from isobutylene and typically an aluminum based catalyst. There are also more reactive PIB compounds and compositions having a higher percentage of unsaturation at the end of the PIB molecule primarily being made from more selective fluorine containing catalysts such as BF₃.

It is well known that the variance in PIB compounds and compositions, the difference in unsaturation, more particularly the alpha vinylidene content, depend on the process conditions such as concentration of isobutylene, temperature, catalyst, and solvents used.

The reactivity of PIB determines in most cases its use and ultimately the performance of the final product in which it is used. Conventional PIB is used in for example, sealants, caulks, and adhesive, packaging and greases. The more reactive PIB is used primarily in lubricants and fuel additives, however, conventional PIB is also used. Other uses include sizing applications, oxirane derivatives, and use in rubber compositions.

PIB, preferably the more reactive PIB, is primarily used for making well known lubricants such as polyisobutylene succinic imide or polyisobutylene succinic amide (PIBSI). PIBSI is formed by reacting polyisobutylene succinic anhydrides (PIBSA) or polyisobutylene succinic acid, an intermediate to PIBSI, with a monoamine or polyamine, in particular a primary amine. PIB, being mostly non-polar, requires the reaction with for example maleic anhydride forming a polar group for enabling the reaction of a linking group, namely succinic anhydride to form PIBSA. This technology is well known in the art and described in numerous patents and publication including U.S. Pat. No. 7,339,007, and 9,315,761 which are herein fully incorporated by reference.

Most commercial PIBSI are made using a thermal process beginning with PIB having a relatively high proportion of terminal vinylidene bonds, referred to in the industry as “reactive or highly reactive” PIB's. High or medium reactive PIB's are well known in the art and are further described in U.S. Pat. Nos. 6,562,913 and 9,309,339, which is herein fully incorporated by reference. Conventional PIB typically has a relatively low content of terminal vinylidene bonds, see for example U.S. Pat. No. 3,272,746.

The thermal and halogen-assisted reactions described above tend to produce significant amounts of haze, and highly colored sediment byproducts which must be filtered from the final product, PIBSI, prior to its use. The thermal process tends to produce tars during the reaction, which coat the reactor walls, necessitating frequent, time-consuming, and therefore costly clean-ups of the reactor vessel. Sediment and tar formation are believed to be due, at least in part, to the decomposition and/or polymerization of the unsaturated enophile, which is typically maleic anhydride. Efforts have been made to eliminate the haze and sediment produced as demonstrated by U.S. Pat. Nos. 7,339,007, 4,958,034, 5,021,169 and 5,241,003.

U.S. Pat. No. 3,794,586 is directed to lubricating oil compositions comprising the reaction between a polyolefin epoxide and an amine compound, including polyisobutylene epoxide to form the reaction product of mono-polyisobutylene hydroxyalkyl-substituted polyetheramine. U.S. Pat. Nos. 6,497,736 and 6,346,129 discloses fuel compositions containing mono-polyisobutylene hydroxyalkyl-substituted amines for use as automotive fuel detergents. In addition, Canadian Patent Application CA 2,856,684A1 describes an amine mixture of a mono-polyisobutylene amine and aliphatic amine for use in cleaning inlet valves and injection nozzles in engines.

Polyetheramines are well known aliphatic organic species in the industry based on both an ether group and an amine group. Typically, polyetheramines are made by reacting an ethylene oxide or propylene oxide with polyols and followed by amination. Polyetheramines are commercially available in a variety of molecular weights with a mono-, di-, and tri-, functionality. Primary uses for polyetheramines are as epoxy resin curing agents and as a fuel additive or detergent for preventing sludge and other deposits in gasoline engines. See for example U.S. Pat. Nos. 4,975,096, 5,489,630, 7,550,550 and 9,315,761, US Patent Publication Nos. 2013/0023455A1 and 2018/0023020A1, and European Patent EP128715B1.

U.S. Pat. Nos. 7,820,604, 7,928,044 and 7,816,309 and European Patent EP2797970B1 discuss copolymers and terpolymers of polyisobutylene and maleic anhydride and polyisobutylene/maleic anhydride/hexadecene compositions reacted with polyetheramines to make oil additives. U.S. Pat. No. 9,315,761 is directed to using epoxides of metallocene-made vinyl terminated polypropylene copolymers and vinyl terminated atactic polypropylene and reacting these polymers with a polyetheramine. US Patent Publication US2018/002320A1 discloses a typical PIBSI reaction with a polyetheramine to make a polyisobutylene polyether imide. These compounds would have properties very similar to PIBSI, retains unsaturation in the final product, and is not an alcohol amine.

US Patent Publication US2014/0087983A1 published Mar. 27, 2014, is directed to a lubricant and fuel dispersants containing an amination product of an epoxidized vinyl terminated macromonomer and an amino compound such as a poly-alkylene polyamines such as ethylene diamines but does not refer to polyetheramines.

US Patent Publication US2006/0063844A1 published Mar. 23, 2006, is directed to a mono-amine functionalized primarily mono-polyisobutylene and mixtures of mono- and bis-poly-isobutyl mono-amines, methods of making amine-functionalized polyisobutylene for use, primarily, in microemulsions coating applications.

While making certain polyisobutylene alcohol amines from polyisobutylene epoxides is known, there is need to improve the chemistry of the head group that influences the final compounds' solubility, reactivity, and performance criteria in various applications from fuel and motor oil lubricant additives, adhesives and sealants, epoxy and polyurea coatings, composites, emulsion stabilizers, paraffin inhibitors, and the like. In addition, there continues to be a need in the art to produce these compounds in an efficient one pot synthesis that produces little to no byproducts for improved compounds or compositions that provides for improved multi-functional chemical and physical properties.

### SUMMARY OF INVENTION

The invention is directed to a new compound(s) or composition, its manufacture and use. These new compound(s) and compositions are selected from the general group of polyisobutylene polyether alcohol amine (PIB-PEAA), more specifically a mono-polyisobutylene polyether alcohol amine (mPIB-PEAA), a bis-polyisobutylene polyether alcohol amine (bPIB-PEAA), a tris-polyisobutylene polyether alcohol amine (tPIB-PEAA), and a tetrakis-polyisobutylene polyether alcohol amine (tkPIB-PEAA). The invention is also directed to mixtures of two or more of a mPIB-PEAA, bPIB-PEAA, tPIB-PEAA and tkPIB-PEAA.

The novel compound or composition, in one embodiment is a mono-polyisobutylene polyether alcohol amine (referred to herein as mPIB-PEAA), is represented by the following general Formula (1):

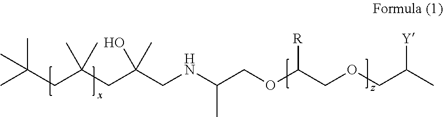

wherein x is an integer from 1 to about 200, preferably from 1 to about 150, and most preferably from 1 to 100, R is H or alkyl group having 1 to 10 carbon atoms, most preferably R is CH₃, and z is an integer from 1 to about 100, preferably from about 1 to 75 and most preferably from 2 to 50, and Y′ is an alkyl group having from 1 to 10 carbon atoms, preferably a CH₃ or an amino group such as (—NH₂), most preferably in all embodiments of formula (1) above, Y′ is an amino group (—NH₂). In one embodiment of the general formula (1) above, x is an integer from 75 to 125, preferably x is 100, z is an integer from 2 to 35, and Y′ is an amino group (—NH₂). In another embodiment of the general formula (1) above, x is an integer from 35 to 75, preferably x is 50, z is an integer from 2 to 10, and Y′ is an amino group (—NH₂). In yet another embodiment of the general formula (1) above, x is an integer from 90 to 110, z is an integer from 2 to 35, and Y′ is an amino group (—NH₂). In still yet another embodiment of the general formula (1) above, x is an integer from 40 to 60, z is an integer from 2 to 10, and Y′ is an amino group (—NH₂).

In another embodiment, the novel compound or composition, in another embodiment is a mPIB-PEAA represented by the following general Formula (2):

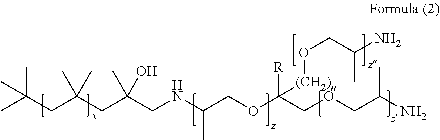

wherein x is an integer from 1 to 200, preferably from 1 to about 150, and most preferably from 1 to 100, R is H or an alkyl group having from 1 to 10 carbon atoms, preferably R is an ethyl group, n is an integer from 1 to 20, and z, z′ and z″ are the same or different, preferably the same, and are integers independently from 5 to 100, more preferably from the lower end of 5 to 6, to an upper end of about 90, and most preferably from 5 to 6, to 85.

The novel compound or composition, in another embodiment is a mPIB-PEAA that is represented by the following general Formula (3):

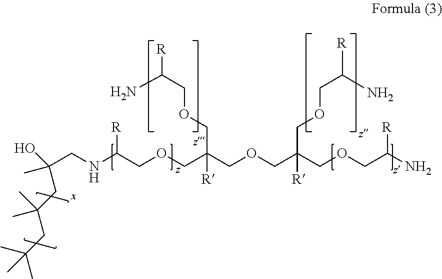

wherein R and R′ are independently hydrogen, methyl or ethyl, or a C1-C5 alkyl group, and x is an integer from 1 to 200, preferably from 1 to about 150, and most preferably from 1 to 100, and z, z′, z″ and z′″ are the same or different, preferably the same, and are integers independently from 5 to 100, more preferably from the lower end of 5 to 6, to an upper end of about 90, and most preferably from 5 to 6, to 85.

The novel compound or composition, in one embodiment is a bis-polyisobutylene polyether alcohol amine (referred to herein as bPIB-PEAA), is represented by the following general Formula (4):

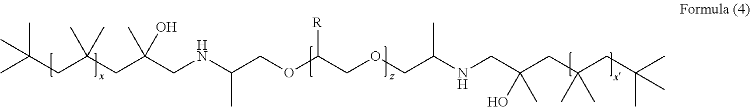

wherein x and x′ are the same or different, preferably the same, and are integers independently from 1 to 200, preferably from 1 to about 150 and most preferably from 1 to 100, R is H or an alkyl group having from 1 to 10 carbon atoms, most preferably R is CH₃, z is an integer from 1 to about 100, preferably from about 1 to 75, and most preferably from about 2 to 50. In one embodiment of the general Formula (4) above, x and x′ are the same or different, preferably the same, and are integers independently from 75 and 125, more preferably x and x′ is 100, z is an integer from 2 to 35. In another embodiment of the general Formula (4) above, x and x′ is 50 and z is an integer from 2 to 10. In yet another embodiment of the general Formula (4) above, x and x′ are the same or different, preferably the same, and are integers independently from 90 to 110 and z is an integer from 2 to 35. In still yet another embodiment of the general Formula (4) above, x and x′ are the same or different, preferably the same, and are integers independently from 40 to 60 and z is an integer from 2 to 10.

The novel compound or composition, in another embodiment is a bPIB-PEAA is represented by the following general Formula (5):

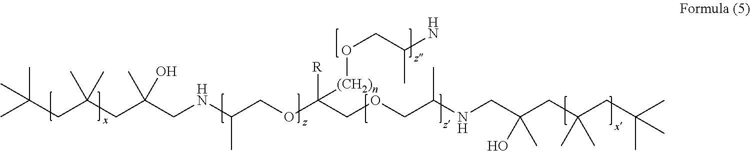

wherein x, and x′ are the same or different, preferably the same, and are integers independently from 1 to 200, preferably from 1 to about 150, and most preferably from 1 to 100, R is H or an alkyl group having from 1 to 10 carbon atoms, preferably R is an ethyl group, and z, z′ and z″ are the same or different, preferably the same, and are integers independently from 5 to 100, more preferably from the lower end of 5 to 6, to an upper end of about 90, and most preferably from 5 to 6, to 85.

The novel compound or composition, in another embodiment is a bPIB-PEAA is represented by the following general Formula (6):

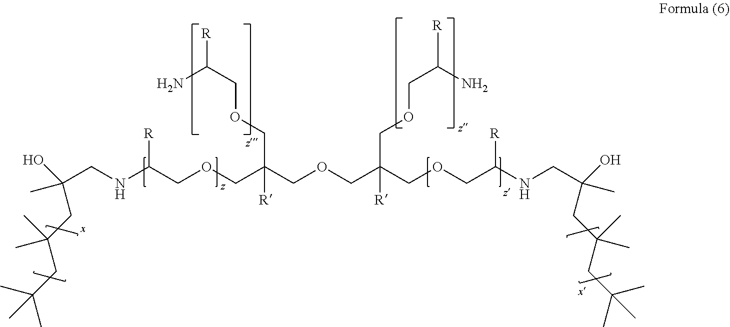

wherein each R is independently hydrogen, methyl or ethyl, R′ is a C1-C5 alkyl group, and x and x′ are the same or different, preferably the same, and are integers independently from 1 to 200, preferably from 1 to about 150, and most preferably from 1 to 100, and z, z′, z″ and z′″ are the same or different, preferably the same, and are integers independently from 5 to 100, more preferably from the lower end of 5 to 6, to an upper end of about 90, and most preferably from 5 to 6, to 85.

The novel compound or composition, in one embodiment is a tris-polyisobutylene polyether alcohol amine (referred to herein as tPIB-PEAA), is represented by the following general Formula (7):

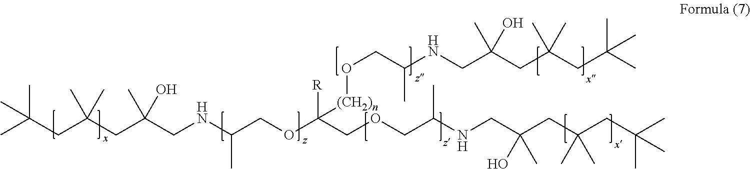

wherein x, x′ and x″ is the same or different, preferably the same, and are integers independently from 1 to 200, preferably from 1 to about 150, and most preferably from 1 to 100, R is H or an alkyl group having from 1 to 10 carbon atoms, preferably R is an ethyl group, n is an integer from 1 to 20, and z, z′ and z″ are the same or different, preferably the same, and are integers independently from 5 to 100, more preferably from the lower end of 5 to 6, to an upper end of about 90, and most preferably from 5 to 6, to 85.

The novel compound or composition, in another embodiment is a tPIB-PEAA is represented by the following general Formula (8):

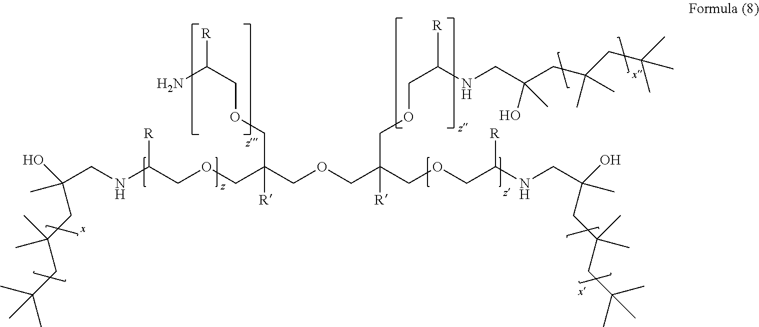

wherein each R is independently hydrogen, methyl or ethyl, R′ is a C1-C5 alkyl group, and x, x′ and x″ are the same or different, preferably the same, and are integers independently from 1 to 200, preferably from 1 to about 150, and most preferably from 1 to 100, and z, z′, z″ and z″ are the same or different, preferably the same, and are integers independently from 5 to 100, more preferably from the lower end of 5 to 6, to an upper end of about 90, and most preferably from 5 to 6, to 85.

The novel compound or composition, in one embodiment is a tetrakis-polyisobutylene polyether alcohol amine (referred to herein as tkPIB-PEAA), is represented by the following general Formula (9):

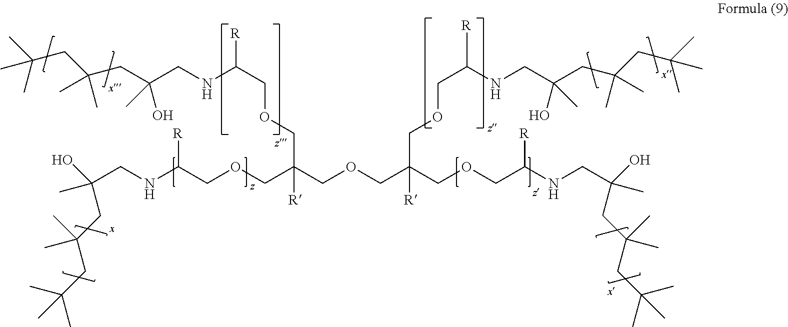

wherein each R is independently hydrogen, methyl or ethyl, R′ is a C1-C5 alkyl group, and x, x′, x″ and x′″ are the same or different, preferably the same, and are integers independently from 1 to 200, preferably from 1 to about 150, and most preferably from 1 to 100, and z, z′, z″ and z′″ are the same or different, preferably the same, and are integers independently from 5 to 100, more preferably from the lower end of 5 to 6, to an upper end of about 90, and most preferably from 5 to 6, to 85.

The process for making the polyisobutylene polyether alcohol amine (PIB-PEAA) compounds of the invention comprises reacting (a) a polyisobutylene epoxide (PIBEP) and a polyetheramine (PEA) in the presence of a diluent and optionally a Lewis Acid or Bronsted Acid catalyst. In a preferred embodiment the polyisobutylene epoxide is selected from one or more of a Type 1, 2 or 3 polyisobutylene epoxide represented by the Formulas 10, 11 and 12, respectively:

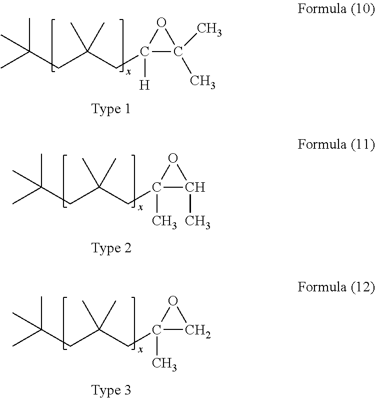

wherein x is an integer from 1 to about 200, preferably 1 to about 150 and most preferably between 1 to 100.

In one embodiment, the hydrophilic polyetheramine may be a mono-, di-, tri-, tetra- or multifunctional polyetheramine. Methods for preparing hydrophilic polyetheramines are well known and can be found in, for example, U.S. Pat. Nos. 3,654,370, 3,832,402, 4,990,476 and 2017/0362164A1 the contents of which are incorporated herein by reference. In general, these hydrophilic polyetheramines may be produced by alkoxylating a mono-, di-, tri-, tetra- or multifunctional alcohol or alkyl phenol with an alkylene oxide, such as ethylene oxide, propylene oxide, butylene oxide or mixtures thereof, to form an alkylene oxide adduct, and then catalytically aminating the alkylene oxide adduct in the presence of hydrogen and ammonia to form the polyetheramine. In some embodiments, the hydrophilic polyetheramine may be initiated by an amine which is alkoxylated and then aminated.

According to one embodiment, the polyetheramine, preferably a hydrophilic polyetheramine is a polyether monoamine having the Formula (13) or Formula (14):

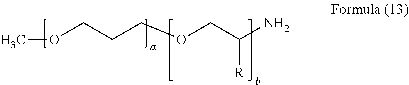

wherein R is hydrogen or methyl, and a and b independently are integers from about 1 to about 150; or

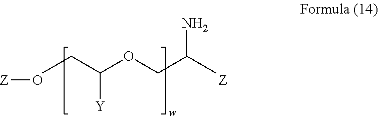

wherein Y is hydrogen or methyl, Z is an alkyl group from 1 to 40 carbon atoms, or a alkyl phenol group of from 1 to 40 carbon atoms, and w is an integer from about 1 to about 100.

In another embodiment, the hydrophilic polyetheramine is a polyether monoamine having one of the Formula (15) or Formula (16):

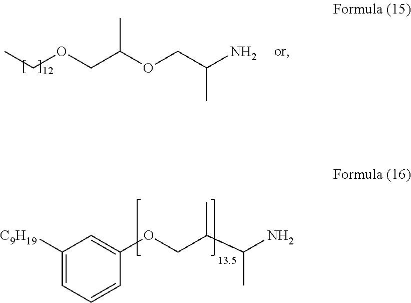

Commercially available polyether monoamines include the JEFFAMINE® M-series and XTJ-series amines, including, but not limited to, JEFFAMINE® M-600, M-1000, M-2005, M-2070, XTJ-435 and XTJ-436 amines, available from Huntsman Corporation.

In another embodiment, the hydrophilic polyetheramine is a polyether diamine having one or more of the Formula (17), Formula (18) and Formula (19):

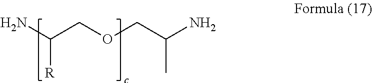

wherein c is an integer from about 2 to about 100, and c is preferably an integer from about 2 to about 40; or

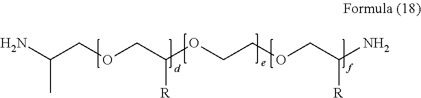

wherein e in an integer from 2 to about 40, and d and f independently are integers from about 1 to about 10; or

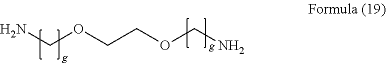

wherein g is an integer from about 2 to about 3.

Commercially available polyether diamines include the JEFFAMINE® D, ED and EDR amines, including, but not limited to, JEFFAMINE® D-200, D-400, D-2000, D-4000, ED-600, ED-900, ED-20003, EDR-148 and EDR-176 amines, available from Huntsman Corporation.

In yet another embodiment, the hydrophilic polyetheramine is a polyether triamine having the Formula (20):

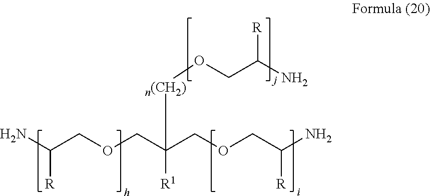

wherein R₁ is hydrogen, methyl or ethyl, n is an integer of 0 or 1, and h, i and j independently are integers from about 1 to about 100.

Commercially available triamines include the JEFFAMINE® T-series amines, including, but not limited to, JEFFAMINE® T-403, T-3000 and T-5000 amines, available from Huntsman Corporation.

In still another embodiment, the hydrophilic polyetheramine is a polyether tetraamine having the Formula (21):

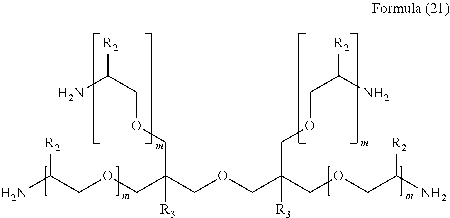

wherein each R₂ is independently hydrogen, methyl or ethyl, R₃ is a C1-C10 alkyl group, and each M independently is an integer from about 2 to about 50.

Generally, the process for making the polyisobutylene polyether alcohol amine compounds of the invention are made by contacting a polyisobutylene epoxide, hydrophilic polyetheramine, a diluent, optionally a protic solvent, and optionally a catalyst in a reactor vessel at a pressure, temperature and reaction time sufficient to form the inventive compounds.

In one embodiment, the polyisobutylene polyether alcohol amine compounds of the invention are produced by the process comprising the steps of: (i) mixing in a reactor vessel a polyisobutylene epoxide with a hydrophilic polyetheramine in a mole ratio (amine:epoxide), of about 1:1 or less (ii) optionally introducing to the reactor vessel a diluent with or without a catalyst, (iii) optionally adding a protic solvent to the reactor vessel, (iv) heating the reactor vessel under pressure for a period of time, (v) optionally removing the diluent, and (vi) recovering the polyisobutylene polyether alcohol amine compound.

In another embodiment, the process of the invention is directed to a process for making a polyisobutylene polyether alcohol amine compound, the process comprising the steps of: (i) mixing in a reactor vessel a polyisobutylene epoxide with a hydrophilic polyetheramine in a mole ratio (amine:epoxide) of about 1:1 or less, (ii) optionally introducing to the reactor vessel a diluent with or without a catalyst, (iii) optionally adding a protic solvent, (iv) heating the reactor vessel under pressure for a period of time, (v) optionally removing the diluent and (vi) recovering the polyisobutylene polyether alcohol amine compound.

In one preferred embodiment, the invention is directed to a process for making a PIB-PEAA composition, the process comprising the steps of: (i) contacting in a reactor a polyisobutylene epoxide and a hydrophilic polyetheramine in a mole ratio (amine:epoxide) of hydrophilic polyetheramine to polyisobutylene epoxide of less than 0.9:1; (ii) optionally introducing a protic solvent; (iii) optionally adding a catalyst to the reactor; and (iv) adding a diluent to the reactor; (iv) removing the diluent to form the PIB-PEAA composition comprising greater than 50 mole percent (50 mol %) PIB-PEAA.

It has surprisingly been discovered that, among other findings, that controlling the mole ratio of polyetheramine (PEA) to polyisobutylene produces a very pure compound with the percentage of minor components reduced or virtually eliminated.

In one general embodiment, in the process for making the PIB-PEAA compounds and compositions of the invention, the mole ratio of polyetheramine to isobutylene epoxide of less than 1:1, preferably less than 0.9:1 and more preferably 0.8:1, and even more preferably 0.7:1, and still even more preferably from less than 0.6:1, or 0.5:1 or less. In another preferred embodiment molar ratio between polyetheramine and the isobutylene epoxide is in the range of from less than 1:1 to 0.2:1, more preferably 0.9:1 to 0.2:1, even more preferably from 0.8:1 to 0.2:1, and still more preferably from 0.7:1 to 0.2:1, and yet even still more preferably from 0.6:1 to 0.3:1, and most preferably from 0.5:1 to 0.2:1.

The polyetheramines are produced containing a targeted amine content. That is, a polyether can contain one molar equivalent of primary amine (monoamine) and/or alternatively two molar equivalents primary amines (diamine) and/or molar three equivalents primary amine (triamine) and/or four molar equivalents of primary amine (tetraamine) and/or potentially higher (polyamine). Choosing the amine content of any particular polyetheramine is determined by the particular end-use application or alternatively the desired end use properties.

In one embodiment a mono-PIB-PEAA is produced using a mole ratio of polyetheramine (one or more of a mono-, di-, tri- and tetra-amine) to polyisobutylene epoxide of less than 1.2:1, preferably less than 1.1:1, more preferably less than 1.05:1 and most preferably about 1:1.

In another embodiment a bis-PIB-PEAA is produced using a mole ratio of polyetheramine (one or more of a di-, tri- and tetra-amine) to polyisobutylene epoxide of less than 0.7:1, preferably less than 0.6:1, more preferably less than 0.55:1, and most preferably about 0.5:1.

In another embodiment a tris-PIB-PEAA is produced using a mole ratio of polyetheramine (one or more of a tri- and tetra-amine) to polyisobutylene epoxide of less than 0.5:1, preferably less than 0.45:1, more preferably less than 0.4:1 and most preferably about 0.3:1.

In another embodiment a tetrakis-PIB-PEAA is produced using a mole ratio of polyetheramine (tetrakis-amine or higher) to polyisobutylene epoxide of less than 0.4:1, preferably less than 0.35:1, more preferably less than 0.3:1 and most preferably about 0.25:1.

In another embodiment, the mole ratio of polyetheramine to polyisobutylene epoxide is such that a little to a slight excess of polyisobutylene epoxide is used. In another embodiment, the mole ratio of polyetheramine to polyisobutylene epoxide is such that a little to a slight excess of polyetheramine is used. The preferred mole ratio for polyetheramine to polyisobutylene epoxide is such that for every mole of polyetheramine one, two, three or four moles of polyisobutylene epoxide is used, to produce mono-, bis-, tris- or tetrakis-PIB-PEAA depending on the number of primary amines contained in the PEA.

In the above process, in another embodiment, when the hydrophilic polyetheramine to polyisobutylene epoxide is as described above, the specific PIB-PEAA composition comprises greater than 70 mol %, preferably greater than 80 mol % more preferably greater than 90 mol % and most preferably greater than 95 mol % the PIB-PEAA.

The polyisobutylene polyether alcohol amine compounds are useful in many applications including friction modification, dispersion agents, fuel additives, emulsion stabilizers, surfactants, adhesives, battery applications, etc.

### DESCRIPTION OF THE DRAWINGS

The present disclosure is illustrated by way of example, and not by way of limitation, in the accompanying drawings, in which like reference characters refer to like parts throughout, and in which:

FIG. 1 illustrates a GPC characterization of mono-polyisobutylene alcohol amine of the invention on a logarithmic scale.

FIG. 2 illustrates a GPC characterization of bis-polyisobutylene alcohol amine of the invention on a logarithmic scale.

FIG. 3 illustrates a GPC characterization of tris-polyisobutylene alcohol amine of the invention on a logarithmic scale.

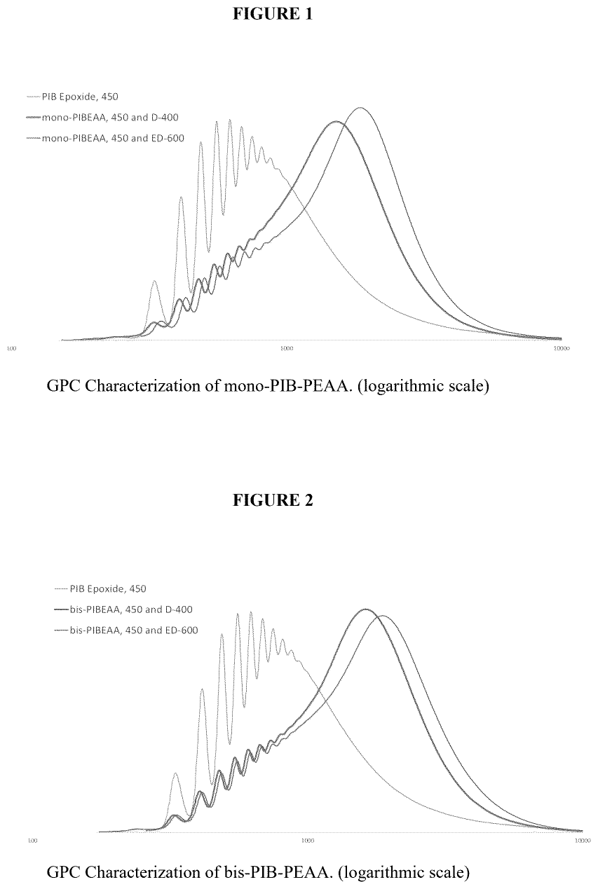

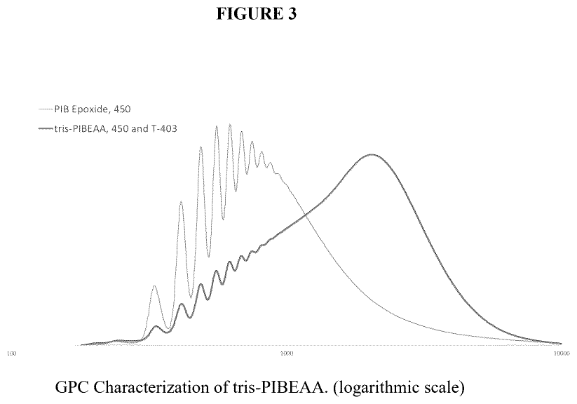

While the disclosed process and composition are susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Disclosed herein are new polyisobutylene polyether alcohol amine (PIB-PEAA) compounds, namely mono-polyisobutylene polyether alcohol amine (mPIB-PEAA), bis-polyisobutylene polyether alcohol amine (bPIB-PEAA), tris-polyisobutylene polyether alcohol amine (tPIB-PEAA), and tetrakis-polyisobutylene polyether alcohol amine (tkPIB-PEAA) and to a process for making PIB-PEAA from polyisobutylene epoxide (PIBEP) with a mono or polyfunctional polyetheramine, and to the many uses for PIB-PEAA. For purposes of this patent specification and appended claims the term polyisobutylene polyether alcohol amine (PIB-PEAA) refers to independently each of the compounds mPIB-PEAA, bPIB-PEAA, tPIB-PEAA and tkPIB-PEAA.

### Polyisobutylene and Making the Polyisobutylene Epoxide.

The polyisobutylene epoxide of the presently employed PIB-PEAA reaction product is obtained by oxidizing a polyalkene with an oxidizing agent to give an alkylene oxide, or epoxide, in which the oxirane ring is derived from oxidation of the double bond in the polyalkene. A preferred polyalkene is polyisobutylene.

Polyisobutylene (PIB) is a long chain molecule synthesized by polymerizing or linking isobutylene molecules. There are many processes well known in the art for making PIB including but not limited to U.S. Pat. Nos. 9,598,655, 9,617,363, 9,309,339, 6,562, 913, 8,524,843, 8,946,361, 11,326,004, 9,074,026 and 9,809,665 and EP1381637B2, which are all fully incorporated by reference.

PIB comes in many forms with a wide range of molecular weights from a few hundred to a few million, typically the preferred use number average molecular weight (Mn) is in the range of from 100 to 5000, preferably 400 to 4000 and most preferably around 500 to about 3500 or less. In addition, PIB as a result of the differing chain lengths also having a wide range of polydispersity index (PDI), measured by GPC using polyisobutylene standards, typically in the range of from about 1.3 to less than 5, more preferably from about 1.4 to less than 4, and most preferably from about 1.5 to less than 3. Together the Mn and PDI are key properties for determining useful PIB viscosities and flash points for specific uses.

PIB is available from many commercial manufactures such as TPC Group, INEOS Oligomers, Infineum, Lubrizol and BASF, each supplying various combinations of low, medium and highly reactive PIB such as GLISSOPAL® and OPPANOL® from BASF Corporation, Ludwigshafen, Germany, Indopol® products available from INEOS Oligomers, London, UK, LUBRIZOL 3108 available from The Lubrizol Corporation, Wickliffe Ohio.

Various types of PIB are available from TPC Group, Houston, TX including highly reactive PIB (HR-PIB) such as HR 545, HR595 and HR 5230, medium reactive PIB (LM-PIB) such as TPC 175 and TPC 1160 and di-isobutylene (DIB) and triisobutylene (TIB).

The determining factor for differentiating between medium and highly reactive PIB is the degree of polymerization based on the concentration of various double bond end group types, i.e., alpha, beta, tetrasubstituted, trisubstituted, and substituted alpha among others. The difference between the PIB can be determined by measuring the PIB alpha-vinylidene content. Conventional or low to medium have between 0 and 10% alpha-vinylidene isobutylene isomer content, whereas highly reactive PIB has between 60% to 90% or greater alpha-vinylidene isobutylene isomer content.

Surprisingly, it has been further found that the PIB-PEAA of the invention can be made using conventional or highly reactive PIB as the starting monomer for making the polyisobutylene epoxide. In one embodiment, a highly reactive PIB is preferred in the process for making the polyisobutylene epoxide starting monomer in the process of the invention to be reacted with a polyetheramine.

### Epoxidation of Alkenes and Other Polymers

Epoxidation of a broad variety of alkenes, including polymers with double bonds, is in general known in the art. Representative prior art showing various procedures for epoxidizing a number of types of unsaturated materials is found at: Song et al., J. Polym. Sci. Polym. Chem. Vol. 40, pp. 1484-1497 (2002); Shigenobu et al. (Maruzen Petrochemical); JP Patent Application No. JP2001 031716A, published Feb. 26, 2001; Suzuki et al., Journal of Applied Polymer Science, Vol. 72, pp. 103-108 (1999); and Li et al.: Macromolecules, Vol. 38, pp. 6767-6769 (2005). Epoxidation of non-polymeric materials using catalysts or selected reaction medium solvents is also in general known in the art. Representative prior art references showing these kinds of epoxidation includes: Hellmann et al., Angew Chem. Int. Ed. Engl. Vol. 30, No. 12, pp. 1638-1641 (1991); Van Vliet et al., Chem. Commun., pp. 821-822, (1999); and Neimann et al., Org. Letters, Vol. 2, No. 18, pp. 2861-2863 (2000). Examples of different types of intermediate polyisobutylene epoxides which are produced according to the present invention are set forth in the following by the following reaction illustrations, referred throughout as Type 1, 2 or 3 polybutylene represented by the Formulas 10, 11 and 12, respectively:

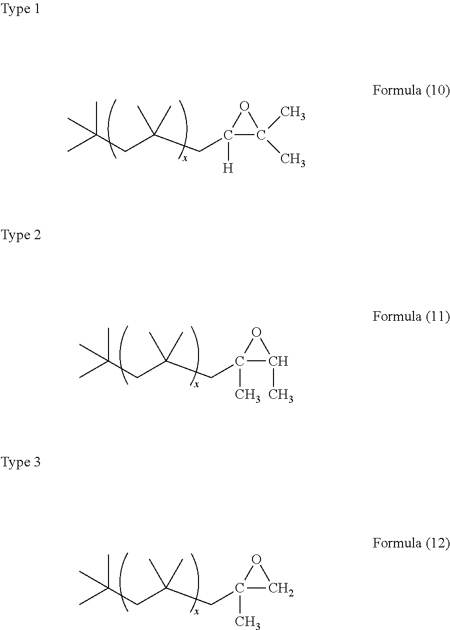

wherein x is from 1 to about 200, preferably 1 to about 150, more preferably 1 to about 100 and most preferably between 1 to 50, and content of polyisobutylene epoxide species bearing Type 1, 2 and/or 3 polyisobutylene epoxides of at least 50 mol %, more preferably 60 mol % and most preferably 80 mol % or greater. In one embodiment of the general formula above x is 100, and in another embodiment, x is 50. In yet another embodiment, of the general formula above x is an integer in the range of from 90 to 110, and in another embodiment, x is an integer in the range of from 40 to 60.

It is generally believed that Type 3 epoxides possess higher reactivity toward amination than Type 1 and Type 2, these polyisobutylene epoxides are preferred. However, it has been surprisingly found that epoxides of Type 1 and Type 2 also exhibit reactivity toward amination. Therefore, polyisobutylene epoxides that contain higher amounts of Type 1 and Type 2 epoxy groups are also useful in the present invention. In any case, if Type 3 epoxides are desired, they are produced starting with polyisobutylene containing high concentrations of Type 3 double bonds (shown above).

In a preferred embodiment the mole percent of Type 1, 2 and/or 3 polyisobutylene epoxide is used in the process of the invention in an amount of at least 30 mol %, preferably at least 40 mol %, more preferably at least 50 mol %, even more preferably at least 60 mol %, and most preferably greater than 70 mol % to about 80 mol %, preferably from about 80 mol % to 85 mol % to about 90 mol % to 95 mol %, most preferably greater than about 95 mol %. In another embodiment, the mole percent of Type 3 polyisobutylene epoxide is used in an amount of at least 50 mol % to about 60 mol %, preferably from about 65 mol % to about 70 mol %, most preferably greater than about 70 mol %. In another embodiment, the mole percent of Type 3 polyisobutylene epoxide is used in an amount of at least 70 mol % to about 80 mol %, preferably from about 80 mol % to 85 mol % to about 90 mol % to 95 mol %. In another embodiment, the mole percent of Type 1 and 3 polyisobutylene epoxide is used in an amount of at least 85 mol % or greater up to about 98 mol %, and most preferably greater than about 90 mol % to 95 mol %.

In one embodiment a combination of Type 1, 2 and 3 polyisobutylene epoxides are used in the process of the invention for making a polyisobutylene polyether alcohol amine. In one preferred embodiment, more than 70 mol %, preferably greater than 80 mol % or even 90 mol % of the polyisobutylene epoxide of Type 3 is used.

In yet another embodiment, the polyisobutylene epoxide (PIBEP) having a number average molecular weight (Mn) in the range of 400 to 5000 and an oxirane oxygen value of 2% to 0.15%, and preferably a Mn in the range of from 400 to 3500 and an oxirane oxygen value of 2% to 0.22%. and more preferably a Mn in the range of from 400 to 3000 and an oxirane oxygen value of 2% to 0.25%.

An example of such a commercially available polyisobutylene containing a high concentration of Type 3 double bonds is TPC 5230, TPC 545, and TPC 595 produced and available from the TPC Group Houston, Texas. Non-limiting examples of polyisobutylene containing a low amount of Type 3 double bonds but elevated levels of Type 1 and Type 2 double bonds are Indopol® H-100, H-300, H-1200, H-1500, H-1900, H-2100, H-6000 and H-18000 produced by INEOS Oligomers, London, UK.

Type 4 tetra-polyisobutylene epoxide is present as a result of the process for making polyisobutylene epoxide and is present with all other Types 1, 2 and 3 in various amounts. For example, Type 4 is present in highly reactive polyisobutylene epoxide, a Type 3, in an amount of about 1 to less than 5 mol %, more likely between 1 mol % to less than 3 mol %, and in a low to medium reactivity polyisobutylene epoxide, a Type 1 and 2, Type 4 is believed present in an amount of between 25 mol % to 40 mol % or higher, more likely about 30 mol % to about 40 mol %.

### Hydrophilic Polyetheramines

In general, these hydrophilic, polyetheramines may be produced by alkoxylating a mono-, di-, tri-, tetra- or multifunctional alcohol or alkyl phenol with an alkylene oxide, such as ethylene oxide, propylene oxide, butylene oxide or mixtures thereof, to form an alkylene oxide adduct, and then catalytically aminating the alkylene oxide adduct in the presence of hydrogen and ammonia to form the polyetheramine.

The polyetheramine useful in reacting with the polyisobutylene epoxide is preferably a hydrophilic polyetheramine, which is a mono-, di-, tri-, tetra- or multifunctional polyetheramine. Methods for preparing hydrophilic polyetheramines are well known and can be found at, for example, U.S. Pat. Nos. 3,654,370, 3,832,402 and 4,990,476, the contents of which are incorporated herein by reference.

The hydrophilic polyetheramines are mono-, di-, tri-, tetra- or multifunctional polyetheramines based on PPG (polypropylene glycol) and PEG (polyethylene glycol) polyether backbones, and polytetramethylene glycol (PTMEG) based polyetheramines or mixtures thereof.

There are many commercial options for the hydrophilic polyetheramines useful for reaction with a polyisobutylene epoxide to make the polyisobutylene polyether alcohol amine compounds of the invention. Huntsman Corporation, Woodlands, TX manufactures polyetheramines under the tradename JEFFAMINE® with various molecular weighs (MW) and Average Amine-Hydrogen Equivalent Weight (AHEW) measured in gram/equivalents. While not wishing to be bound by any particular theory it is believed that selecting the appropriate polyetheramine for a preferred use or application when used in making the polyisobutylene polyether alcohol amine compound of the invention the intended use or application will be improved. For example, it is believed that using a polyetheramine polyisobutylene polyether alcohol amine compound of the invention in an epoxy resin likely will result in an improved epoxy resin with improved water resistance, adhesion, flexibility, etc.

### Monoamines

One type of polyetheramine are known as monoamines, which for the purposes herein are based on PPG or PEG/PPG backbones. Huntsman Corporation manufactures monoamines under the tradename JEFFAMINE® M-series based on propylene glycol that include as an example JEFFAMINE® M-600 having a molecular weight (Mw) of 600 and AHEW of 291 g/eq and M-2005 with a MW of 2000 and AHEW of 1045 g/eq, both of which said to be useful for use with polymers useful in blends with polymers. JEFFAMINE® monoamines based on polyethylene glycol said to be useful for formulating emulsifiers and corrosion inhibitors include M-1000 (MW1000 and AHEW 489 g/eq), M-2070 (MW 2000 and AHEW 1040 g/eq), M-2095 (MW2000 and AHEW 1120 g/eq), and M-3085 (MW 3000 and AHEW 1520 g/eq). Some of these monoamines are said to be useful in epoxy resins, pressure sensitive adhesives and the like.

According to one embodiment, the hydrophilic polyetheramine is a polyether monoamine having one of the Formula (22) or Formula (23):

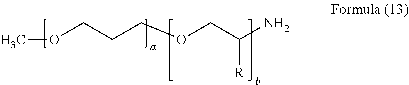

wherein R is hydrogen or methyl, and a and b independently are integers from about 1 to about 150; or

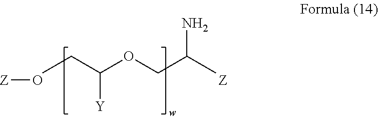

wherein Y is hydrogen or methyl, Z is an alkyl group from 1 to 40 carbon atoms, or a alkyl phenol group of from 1 to 40 carbon atoms, and w is an integer from about 1 to about 100.

In another embodiment, the hydrophilic polyetheramine is a polyether monoamine having one of the Formula (15) or Formula (16):

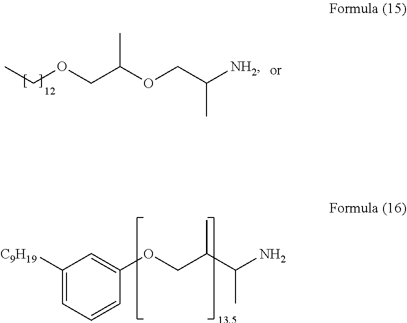

In one embodiment, the mono-polyetheramine having a PPG backbone of the invention is represented by Formula (24):

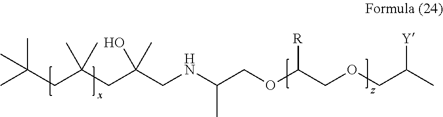

wherein x is an integer from 1 to 200, and Z is an integer from 1 to 85, or alternatively x+z is about 3.6.

Commercially available polyether monoamines include the JEFFAMINE® M-series and XTJ-series amines, including, but not limited to, JEFFAMINE® M-600, M-1000, M-2005, M-2070, XTJ-435 and XTJ-436 amines, available from Huntsman Corporation.

In one embodiment, the polyether monoamines have a molecular weight (Mw) in the range of from 100 to 5000, preferably from 150 to 3500, most preferably from 170 to 3000.

### Diamines

Another type of polyetheramine are known as polyether diamines provided by Huntsman Corporation under the tradename JEFFAMINE® D-series diamines having various backbones that are based on polypropylene glycol, polyethylene glycol, and mixtures thereof, and highly reaction diamines.

Examples of JEFFAMINE® D-series diamines based on polypropylene glycol and having a low color, and miscibility in various solvents are JEFFAMINE® D-230 (MW 230 and AHEW 60 g/eq), D-400 (MW 430 and AHEW 115 g/eq), D-2000 (MW 200 and AHEW 514 g/eq), D2010 (MW 2000 and AHEW ˜514 g/eq), and D-4000 (MW 4000 and AHEW 1000 g/eq). These polyether diamines are said to be useful for impact resistant coatings, hot melt adhesives, blends with polyurethanes, polyurea's, and polyamide adhesives, and the like.

Examples of JEFFAMINE® ED-series diamines based predominantly on a polyethylene glycol backbone that are said to impart complete water solubility and miscibility in solvents, and primarily used to impart hydrophilicity to polymers and additives include: JEFFAMINE® ED-600 (MW 600 and AHEW132 g/eq), ED-900 (MW 900 and AHEW 250 g/eq), and ED-2003 (MW 2000 and AHEW 575 g/eq). These polyether diamines are said to be useful in epoxy resins, blends with polyamides, preparing hydrogels, in coatings, as antistatic agents, treating textiles, and the like.

An example of JEFFAMINE® EDR, highly reactive diamine with a primary use for fast curing adhesives, and polyamide modifications is also available from Huntsman Corporation as JEFFAMINE® EDR-148 (MW 148 and AHEW 37 g/eq). In addition, Huntsman Corporation also manufactures a polyetheramine based on either a [poly(tetramethylene ether glycol)]/(propylene glycol) copolymer or a predominantly [poly(tetramethylene ether glycol)] (PTMEG) backbone. An example of a JEFFAMINE® EDR is JEFFAMINE® THF-100 (AHEW 260 g/eq) said to be useful for improving flexibility and adhesive peel strength in epoxy formulations, and improved flexibility and low temperature properties for use with polyamides.

In another embodiment, the hydrophilic polyetheramine is a polyether diamine having one of the Formula (17), Formula (18) or Formula (19):

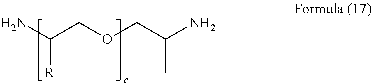

wherein c is an integer from about 2 to about 100, and preferably c is an integer from about 2 to about 40; or

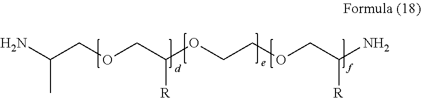

wherein e in an integer from 2 to about 40, and d and f independently are integers from about 1 to about 10; or

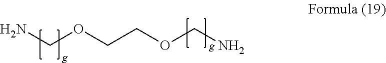

wherein g is an integer from about 2 to about 3.

In one embodiment, the preferred polyetheramine compounds useful are polyetheramines that include JEFFAMINE® D-230 and JEFFAMINE® D-400 as non-limiting examples, available from Huntsman Corporation, Woodlands, TX. These polyetheramines based on polypropylene glycol (PPG) backbone represented by the Formula (25):

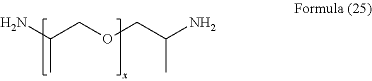

wherein x is 2.5 for JEFFAMINE® D-230 and x is 6.1 for JEFFAMINE® D-400.

In one embodiment, the polyether amine is based on polypropylene glycol (PPG) backbone represented by the Formula (26):

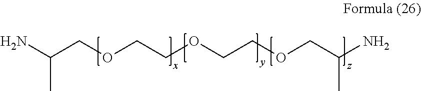

The specific polyetheramines available from Huntsman Petrochemical, LLC., Woodlands, Texas is JEFFAMINE® ED-600 where y is 9, and x+z≈3.6.

Commercially available polyether diamines include the JEFFAMINE® D, ED and EDR amines, including, but not limited to, JEFFAMINE® D-200, D-400, D-2000, D-4000, ED-600, ED-900, ED-2003, EDR-148 and EDR-176 amines, available from Huntsman Corporation.

In one embodiment, the polyether diamines have a molecular weight (Mw) in the range of from 100 to 5000, preferably from 150 to 3000, most preferably from 170 to 2500.

### Triamines

Yet another type of polyetheramine are known as polyether triamines provided by Huntsman Corporation under the tradename JEFFAMINE® T-series based on polypropylene glycol backbones. Examples of JEFFAMINE® T-series triamines include JEFFAMINE® T-403 (MW 440 and AHEW 81 g/eq) and T-5000 (MW 5000 and AHEW 952 g/eq) said to be useful in epoxy resins, miscibility in solvents, improving strength and flexibility in polymers, as a surfactant or corrosion inhibitor and the like.

In yet another embodiment, the hydrophilic polyetheramine is a polyether triamine having the Formula (20):

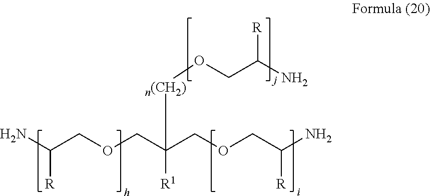

wherein R₁ is hydrogen, methyl or ethyl, n is an integer of 0 or 1, and h, i and j independently are integers from about 1 to about 100.

In one embodiment, the polyetheramine is a triamine based on trifunctional polypropylene glycol (PPG) backbone represented by the Formula (28):

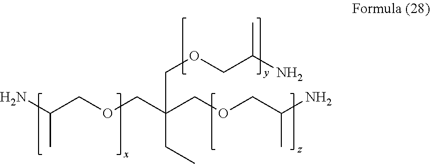

The specific polyetheramines available from Huntsman Petrochemical, LLC., Woodlands, Texas is Jeffamine T-403 where x+y+z≈5 or 6.

Commercially available triamines include the JEFFAMINE® T-series amines, including, but not limited to, JEFFAMINE® T-403, T-3000 and T-5000 amines, available from Huntsman Corporation.

In still another embodiment, the hydrophilic polyetheramine is a polyether tetraamine having the Formula (21):

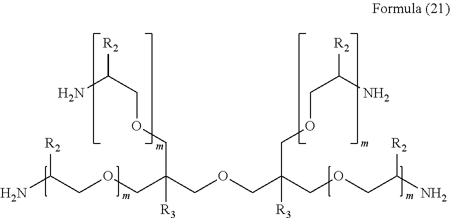

wherein each R₂ is independently hydrogen, methyl or ethyl, each R₃ is a C1-C5 alkyl group, and each M independently is an integer from about 2 to about 50.

In one embodiment, the polyether triamines have a molecular weight (Mw) in the range of from 150 to 5000, preferably from 200 to 3500, most preferably from 200 to 3000.

Other polyetheramines also available from Huntsman Corporation useful in making the polyisobutylene polyether alcohol amine compounds of the invention include: JEFFAMINE® SD-2001 (a di-functional secondary amine derived from JEFFAMINE® D-2000) (AHEW 1000 g/eq) said to be useful in resins providing for better control of reaction and curing speed in applications such as polyurea spray coatings, and D-205 (similar in AHEW to JEFFAMINE® D-230 with a more hindered primary amine) (AHEW 58 g/eq) for slower reacting epoxy resins. In addition, Huntsman Corporation manufactures JEFFAMINE® RFD-270 Amine (AHEW 67 g/eq) containing both a rigid (cycloaliphatic) and flexible (polyetheramine) segments in the same molecule said to be useful in coatings, adhesives and composites.

In still another embodiment, the hydrophilic polyetheramine is a multifunctional polyetheramine. The multi-functional polyetheramine of the present disclosure may be a polyether, di-, tri- or tetra-, amine, such as those described herein and as described in US Patent Publication No. US 2018/0023020A1 published Jan. 25, 2018, to Huntsman Petrochemical LLC, Woodlands, Texas, which is herein fully incorporated by reference in particular for purposes of the disclosure of hydrophilic polyetheramines described therein.

In addition, there are a number of other grades of polyether amines commercially available from Clariant International AG, Switzerland, for example, Genamin T01/5000 a triamine with a terminal primary amine groups based on propoxylated glycol with an average molecular mass of 5000 to 6000 g/mol, Genamin M41/2000 a random ethylene oxide and polypropylene oxide copolymer end-capped with a primary amino group, and Genamin DO1/2000 a high molecular weight, macromonomer with two reactive functional amine groups. Also, BASF, Ludwigshafen, Germany provides commercial grades of polyether amines for example, Polyetheramine D 400, Polyetheramine D-2000, Baxxodur EC310, Baxxodur EC 130 and Baxxodur EC 303. There are a number of Chinese commercial suppliers of polyether amines, for example Yangzhou Chenhua New Material Company, Limited, Qingdao IRO Surfactant Co, Limited, and Wuxi Acryl Technology Co., Limited.

In accordance with the invention, non-exhaustive, exemplary list of other amines compounds include polyetheramines and can be amine-terminated polyether such as polyethylene oxide (PEO), polypropylene oxide (PPO) or combination of PEO/PPO copolymers. For example, some of the commercial polyether include: poly(ethyleneglycol) bis(3-aminopropylether) poly(propyleneglycol) bis(2-aminopropylether) poly(propyleneglycol) bis(2-aminopropylether), poly(propyleneglycol) bis(2-aminopropylether), poly(propyleneglycol) bis(2-aminopropylether) poly(propyleneglycol)-block-poly(ethyleneglycol)-block poly(propyleneglycol) bis(2-aminopropylether) (3.5:8.5, PO:EO) poly(propyleneglycol)-block-poly(ethyleneglycol)-block poly(propyleneglycol) bis(2-aminopropylether) (3.5:15.5,PO:EO) poly(propyleneglycol)-block-poly(ethyleneglycol)-block poly(propyleneglycol) bis(2-aminopropylether) (3.5:40.5, PO:EO) glycerol tris(poly(propylene glycol), amine terminated ether poly(tetrahydrofuran), bis(3-aminopropyl) terminated, and the like.

In one embodiment a mole ratio of polyetheramine to polyisobutylene epoxide of less than 1:1, preferably less than 0.9:1 and more preferably 0.8:1, and even more preferably 0.7:1, and still even more preferably from less than 0.6:1, or 0.5:1 or less. In another preferred embodiment molar ratio between polyetheramine and the isobutylene epoxide is in the range of from less than 1:1 to 0.2:1, more preferably 0.9:1 to 0.2:1, even more preferably from 0.8:1 to 0.2:1, and still more preferably from 0.7:1 to 0.2:1, and yet even still more preferably from 0.6:1 to 0.3:1, and most preferably from 0.5:1 to 0.2:1.

In another embodiment, the mole ratio of polyetheramine to polyisobutylene epoxide is such that a little to a slight excess of polyisobutylene epoxide is used. In another embodiment, the preferred mole ratio for polyetheramine to polyisobutylene epoxide is such that for every mole of polyetheramine used at least two moles of polyisobutylene epoxide is used.

### Process For Making

Generally, the process for making the polyisobutylene polyether alcohol amine compounds of the invention are made by contacting a polyisobutylene epoxide, hydrophilic polyetheramine, a diluent, a protic solvent mixture, and optionally a catalyst in a reactor vessel at a pressure and temperature sufficing to form the inventive compounds.

In one embodiment, the polyisobutylene polyether alcohol amine compounds of the invention are produced by the process comprising the steps of: (i) mixing in a reactor vessel a polyisobutylene epoxide with a hydrophilic polyetheramine in a mole ratio of about 1:1 or less, (ii) optionally introducing to the reactor vessel a diluent with or without a catalyst, (iii) optionally adding a protic solvent to the reactor vessel, (iv) heating the reactor vessel under pressure for a period of time, (v) optionally removing the diluent, and (vi) recovering the polyisobutylene polyether alcohol amine compound.

In another embodiment, the process of the invention is directed to a process for making a polyisobutylene polyether alcohol amine compound, the process comprising the steps of: (i) mixing in a reactor vessel a polyisobutylene epoxide with a hydrophilic polyetheramine in a mole ratio of about 1:1 or less, (ii) optionally introducing to the reactor vessel a diluent with or without a catalyst, (iii) optionally adding a protic solvent, (iv) heating the reactor vessel under pressure for a period of time, (v) optionally removing the diluent and (vi) recovering the polyisobutylene polyether alcohol amine compound.

In another embodiment, the process of the invention is directed to making a polyisobutylene polyether alcohol amine by reacting a hydrophilic polyetheramine with a polyisobutylene epoxide in mole ratio of hydrophilic polyetheramine to polyisobutylene epoxide is preferably about 1:1. In yet another embodiment, the hydrophilic polyetheramine is a product produced by alkoxylating a mono-, di-, tri-, tetra- or multifunctional alcohol or alkyl phenol with an alkylene oxide to form an alkylene oxide adduct, and then catalytically aminating the alkylene oxide adduct in the presence of hydrogen and ammonia to form the polyetheramine.

The reaction to produce PIB-PEAA often results in a PIB-PEAA composition in which predominantly, more than 50 mol %, preferably more than 60 mol %, more preferably greater than 70 mol %, and even more preferably greater than 80 mol % and most preferably more than 90 mol % of the composition is PIB-PEAA. Minor components present in the composition may include mixtures of isomers from the polyetheramine, unreacted polyisobutylene epoxide and byproducts from the initial epoxidation of isobutylene such as mainly alcohols, aldehydes, unreacted polyisobutylene, and very small quantities, if any detectable, of mono-substituted poly-isobutyl alcohol amine in an amount making up less than 2 mol %, typically less than 1 mol % to 0, or not detectable, in the PIB-PEAA composition.

### Diluent

Due to the high viscosity of the polyisobutylene epoxide the amination reaction is desirably carried out in the presence of at least one hydrocarbon diluent. It is believed that when the viscosity is too high the reactive sites are less accessible, and it is difficult for the desired reactant to diffuse to the reactive site.

The desired diluent should be stable and unreactive toward the reactants and the resulting end product, the PIB-PEAA. In an embodiment, at least one diluent is selected from one or more of benzene, toluene, xylenes; saturated aliphatic hydrocarbons such as pentane, hexane, heptane; paraffinic, naphthenic, aromatic base oils for example well known from Group I, Group II, Group III, Group IV or Group V including poly-alpha olefins or any other compound useful for affecting reaction viscosity.

In a preferred embodiment at least one diluent is used optionally in the reaction between the polyisobutylene epoxide and the hydrophilic polyetheramine to improve, among other things, the solubility and mixing in the process. In an embodiment, at least one diluent is selected from one or more of benzene, toluene, xylenes; saturated aliphatic hydrocarbons such as pentane, hexane, heptane; paraffinic, naphthenic, aromatic base oils for example well known from Group I, Group II, Group III, Group IV or Group V including poly-alpha olefins or any other compound useful for affecting reaction viscosity.

The most preferred diluents are those that are easily removed from the final product (toluene, heptane, etc.) or those that can be left in the final mixture (i.e., base oil or PAO).

### Catalyst

Optionally, a catalyst may be used in the inventive process to accelerate the rate of reaction and improve overall conversion to PIB-PEAA product and composition. Such catalysts are well known in the art and used depending on the process, reactor configuration, reaction conditions, monomers, etc. Non-limiting examples of a suitable catalyst include a Lewis acid such as trichloroaluminium, trifluoroboron, tetrachlorotitanium, ferric chloride either alone or as a base adduct, such as BF₃:ether, BF₃:alcohol, etc., or a solid catalyst containing a moiety of Lewis acid and Bronsted acid such as silica, silica-alumina, and also an organic acid and water such as acetic acid and water may be used.

In another embodiment, optionally, a Lewis acid or a Bronsted acid catalyst may be used and selected form one or more of: trichloroaluminium, trifluoroboron, tetrachlorotitanium, ferric chloride; BF₃:ether, BF₃:alcohol; or a solid catalyst containing a moiety of Lewis acid and Bronsted acid such as silica, silica-alumina or an organic acid and water.

The amount of the catalyst is generally from about 0.05 to about 10 weight percent, and preferably from about 0.1 to about 10 weight percent based upon the total weight of the polyalkene epoxide. The most preferred catalyst is a Lewis acid such as boron trifluoride.

### Protic Solvent

In practice, the catalyst is used in combination with a protic solvent or alone. In another embodiment, at least one protic solvent is used in the reaction between the polyisobutylene epoxide, the polyetheramine and the diluent, with or without, a catalyst. In one embodiment, the at least one protic solvent is preferably at least one organic hydroxyl compound, preferably an alcohol or water, and most preferably an alcohol such as methanol or ethanol. The typical amounts of the protic solvent used is less than 1 weight percent based on the weight of polyisobutylene epoxide.

In another preferred embodiment, at least one protic solvent is used in the reaction between the polyisobutylene epoxide, the polyetheramine and the protic solvent, without or without a catalyst. In one embodiment, the at least one protic solvent is preferably at least one organic hydroxyl compound, preferably an alcohol or water, and most preferably an alcohol such as methanol or ethanol. It is believed that when a catalyst is used in combination with a protic solvent, the protic solvent acts as an initiator for the reaction.

### Reactor and Conditions

Depending on the reactor type and configuration the reaction conditions may vary as is well known to one of skill in the art. In one embodiment, the batch process or continuous process for producing the PIB-PEAA utilizes in which in a reactor, preferably jacketed, heated and agitated reactor to a specified temperature and pressure, PIBEP is introduced to the reactor in the presence of a diluent if used, followed by the introduction of a polyetheramine along with a catalyst, optionally with a protic solvent.

In one embodiment, it may be necessary to perform one or more of the steps of: removing the diluent, neutralizing, and removing the catalyst, filtering or optionally washing the rection product as synthesized in the reactor. In another embodiment, the diluent is a base oil, and therefore, the reaction product could be used as is. In one embodiment, the polyetheramine is introduced into the reactor in a staged manner during the reaction process.

The temperature for the above process is typically below the decomposition temperature of the polyisobutylene epoxide. Such non-limiting reaction temperature is generally from about 60° C. to about 260° C., more generally from about 100° C. to about 240° C., desirably from about 150° C. to about 230° C., and most preferably from about 180° C. to about 225° C. Depending on the process, temperatures can be even lower depending on the catalyst and rection process used.

The reaction can either be run in an open vessel under atmospheric conditions, or in a closed vessel under moderate pressure such as up to about 300 psi, desirably from about 10 psi to about 70 psi, and preferably from about 35 psi to about 55 psi. Reaction pressure will be a function of the partial pressures of the individual reaction components at the reaction temperature.

### Polyisobutylene Polyether Alcohol Amine Compound and Compositions

The novel compound or composition, in one embodiment is a mono-polyisobutylene polyether alcohol amine (referred to herein as mPIB-PEAA), is represented by the following general Formula (1):

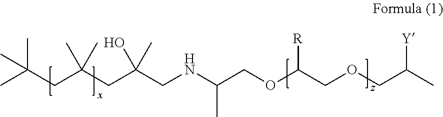

wherein x is an integer from 1 to about 200, preferably from 1 to about 150, and most preferably from 1 to 100, R is H or alkyl group having 1 to 10 carbon atoms, most preferably R is CH₃, and z is an integer from 1 to about 100, preferably from about 1 to 75 and most preferably from 2 to 50, and Y′ is an alkyl group having from 1 to 10 carbon atoms, preferably a CH₃ or an amino group such as (—NH₂), most preferably in all embodiments of formula (1) above, Y′ is an amino group (—NH₂). In one embodiment of the general formula (1) above, x is an integer from 75 to 125, preferably x is 100, and z is an integer from 2 to 35, and Y′ is an amino group (—NH₂). In another embodiment of the general formula (1) above, x is an integer from 35 to 75, preferably x is 50, z is an integer from 2 to 10, and Y′ is an amino group (—NH₂). In yet another embodiment of the general formula (1) above, x is an integer from 90 to 110, z is an integer from 2 to 35, and Y′ is an amino group (—NH₂). In still yet another embodiment of the general formula (1) above, x is an integer from 40 to 60, z is an integer from 2 to 10, and Y′ is an amino group (—NH₂).

The novel compound or composition, in one embodiment is a bis-polyisobutylene polyether alcohol amine (referred to herein as bPIB-PEAA), is represented by the following general Formula (4):

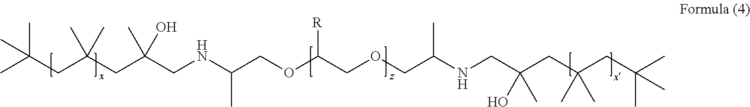

wherein x and x′ are the same or different, preferably the same, and are integers independently from 1 to 200, preferably from 1 to about 150 and most preferably from 1 to 100, R is H or an alkyl group having from 1 to 10 carbon atoms, most preferably R is CH₃, z is an integer from 1 to about 100, preferably from about 1 to 75, and most preferably from about 2 to 50. In one embodiment of the general Formula (4) above, x and x′ are the same or different, preferably the same, and are integers independently from 75 and 125, more preferably x and x′ is 100, z is an integer from 2 to 35. In another embodiment of the general Formula (4) above, x and x′ is 50 and z is an integer from 2 to 10. In yet another embodiment of the general Formula (4) above, x and x′ are the same or different, preferably the same, and are integers independently from 90 to 110 and z is an integer from 2 to 35. In still yet another embodiment of the general Formula (4) above, x and x′ are the same or different, preferably the same, and are integers independently from 40 to 60 and z is an integer from 2 to 10.

In yet another embodiment, the bPIB-PEAA compound of the invention made with a polyether diamine having a PPG backbone is represented by Formula (27):

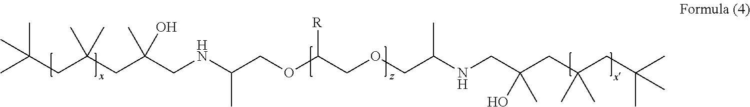

wherein x and x′ is an integer of from 1 to 200, and z is an integer from 1 to 85 or alternatively x+x′+z is 5 or 6.

The novel compound or composition, in one embodiment is a tris-polyisobutylene polyether alcohol amine (referred to herein as tPIB-PEAA), is represented by the following general Formula (7):

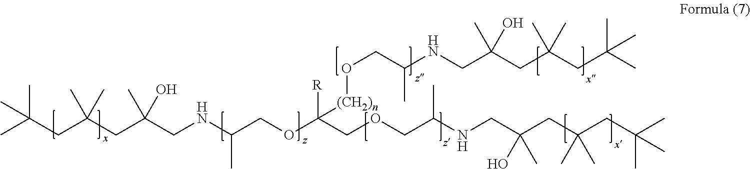

wherein x, x′ and x″ is the same or different, preferably the same, and are integers independently from 1 to 200, preferably from 1 to about 150, and most preferably from 1 to 100, R is H or an alkyl group having from 1 to 10 carbon atoms, preferably R is an ethyl group, n is an integer from 1 to 20, and z, z′ and z″ are the same or different, preferably the same, and are integers independently from 5 to 100, more preferably from the lower end of 5 to 6, to an upper end of about 90, and most preferably from 5 to 6, to 85.

In another embodiment the PIB-PEAA composition comprises the PIB-PEAA compound(s) above in a percentage above 50 mol % based on the PIB-PEAA composition, more preferably above 60 mol % even more preferably greater than 70%, and most preferably greater than 80 mol %.

In another embodiment, the reaction to produce PIB-PEAA often results in a PIB-PEAA composition in which predominantly, more than 55 mol %, preferably more than 65 mol %, more preferably greater than 75 mol %, and even more preferably greater than 85 mol %, still even more preferably more than 95 mol %, of the composition is PIB-PEAA. Minor components present in the composition may include mixtures of isomers from the polyetheramine, unreacted polyisobutylene epoxide and byproducts from the initial epoxidation of isobutylene such as mainly alcohols, aldehydes, unreacted polyisobutylene.

In one embodiment, the PIB-PEAA composition comprises: (i) 5 to 98 mol % of one or more polyisobutylene polyether alcohol amine compound(s), (ii) up to 15 mol % of unreacted polyisobutylene, and (iii) up to 15 mol % one or more unreacted polyisobutylene epoxide, wherein the sum of the mol % of i, ii and iii together add to between 98 mol % and 100 mol %.

In one embodiment, the PIB-PEAA composition comprises: (i) 5 mol % to 98 mol % PIB-PEAA, preferably more than 60 mol %, even more preferably more than 70 mol %, and yet even more preferably more than 80 mol %, and especially more than 85 mol % or greater than 90 mol %, (ii) up to 15 mol % unreacted polyisobutylene, preferably less than 10 mol %, more preferably less than 5 mol %, (iii) up to 15 mol % unreacted polyisobutylene epoxide and/or side-products such as polyisobutylene alcohol, preferably less than 10 mol %, more preferably less than 5 mol %, and (iv) preferably less 2 mol % of mono-PIB, more preferably less than 1 mol %, wherein the sum of the mol % from i, ii, iii and iv together add to 100 mol %.

In one embodiment the PIB-PEAA compositions have a number average molecular weight (Mn) in the range of from 800 to 10,000, preferably from 800 to 8000, more preferably from 800 to 7000, and most preferably from 800 to 6000.

In another embodiment the PIB-PEAA compositions have a polydispersity index (PDI) in the range of from 1.2 to 5, preferably from 1.2 to 4, more preferably from 1.2 to 3.5, and most preferably from 1.2 to 3.

In yet another aspect of the PIB-PEAA compositions have a viscosity using ASTM D-445 at 100° C. in the range of from 10 cSt to 10,000 cSt, preferably from 15 cSt to 8000 cSt, more preferably from 20 cSt to 6000 cSt, and most preferably from 25 cSt to 5000 cSt.

The PIB-PEAA composition has any one or more of the above embodiments or aspects in any combination of Mn, PDI, and/or viscosity.

In another embodiment, the PIB-PEAA compound(s) or composition have a Mn in the range of from 800 to 6000, a PDI in the range of from 1.2 to 3, and a viscosity in the range of from 25 cSt to 5000 cSt.

In another embodiment, PIB-PEAA composition of the invention especially where a Type 1 and/or Type 2 is the predominant polyisobutylene epoxide used in forming the PIB-PEAA compound(s), the PIB-PEAA composition comprises an amount of fluorine or chlorine of not more than 10 ppm, preferably less than 5 ppm, more preferably less than 2 ppm, most preferably less than 1 ppm down to 0.

### Uses of the PIB-PEAA

The PIB-PEAA compound(s) and composition(s) is/are useful as an emulsifier, stabilizer, corrosion inhibitor, and dispersant in the formulation of various lubricants, fuels, and water-based fluids.

In particular the PIB-PEAA compound(s) and composition(s) is/are useful as a dispersant additive in fuels. It may also be useful to improve the strength and durability of products such as adhesives, sealants, oils, greases.

The PIB-PEAA compound(s) and composition(s) is/are useful as dispersant additives when employed in lubricating oils. The lubricating oil used with the PIB-PEAA compound(s) and composition(s) of this invention may be mineral oil or synthetic oils of lubricating viscosity and preferably suitable for use in the crankcase of an internal combustion engine. The lubricating oils may be derived from synthetic or natural sources. Mineral oil for use as the base oil in this invention includes paraffinic, naphthenic and other oils that are ordinarily used in lubricating oil compositions. Synthetic oils include both hydrocarbon synthetic oils and synthetic esters. Useful synthetic hydrocarbon oils include liquid polymers of alpha olefins having the proper viscosity.

Lubricating oil concentrates as uses for the disclosed PIB-PEAA compound(s) and composition(s) are also included within the scope of this invention. The concentrates of this invention usually include from about 90 to 50 weight percent of an oil of lubricating viscosity and from about 10 to 50 weight percent of the PIB-PEAA compound(s) and composition(s) of this invention. Typically, the concentrates contain sufficient diluent to make them easy to handle during shipping and storage. Suitable diluents for the concentrates include any inert diluent, preferably an oil of lubricating viscosity, so that the concentrate may be readily mixed with lubricating oils to prepare lubricating oil compositions.

Other additives which may be present in the formulation include rust inhibitors, foam inhibitors, corrosion inhibitors, metal deactivators, pour point depressants, antioxidants, and a variety of other well-known additives and other uses including in adhesive, sealants, greases, emulsifiers, paints and coatings, and polymer formulations.

The lubricating composition above may further comprise an ashless dispersant, a borated ashless dispersant, a non-borated ashless dispersant, a detergent, i.e., calcium salicylate, calcium sulfonate, magnesium phenate. and calcium phenate, or other typical components well known in the relevant art.

Formulations for use in dispersants, lubricants, greases, corrosion inhibitors, gear oils, base stocks are found in US Patent and Publication Nos.: U.S. Pat. Nos. 11,629,308, 10,808,196, 9,926,509, 7,851,418, 8,691,738, 8,399,390, 3,850,822, 11,788,027, 11,773,343, 9,228,152, 9,282,736, 6,844,300, 9,783,630, 7,998,340, 7,820,600, 8,163,682, 6,551,967, 6,001,780, 6,686,321, 5,942,476, 5,360,564, 4,402,841, 3,873,455 and 3,850,822, 10,494,584, 11,732,208, US2023/0323234AA, U.S. Pat. Nos. 10,793,802, 10,781,411, 10,611,981, 10,358,616, 11,685,872, 11,059,924, 10,829,712, 11,136,523, 10,781,393, 10,640,724, 11,346,643, 11,680,782, 11,034,912, 11,427,515, 11,788,027, 11,788,026, and 11,608,477, which are all fully incorporated by reference such that one of ordinary skill in the art would consider replacing one or more components in the above formulations in particular those components functioning similarly to PIBSI or other polymers useful in a lubricating oil formulation.

Non-limiting examples of potential uses for the PIB-PEAA compound(s) or composition(s) is/are in the explosive emulsion formulations discussed in U.S. Pat. Nos. 4,933,028, 5,026,442, 5,160,387, 5,670,739, 5,470,407, 6,514,361, 6,165,297 U.S. Pat. Nos. 8,603,959, 7,972,454, 5,920,031, 7,044,988, 5,936,194, 6,929,707, 6,939,420, 6,800,154, 6,951,589, 5,527,491 and 4,844,756 all of which are fully incorporated by reference in which the PIB-PEAA is generally substituted for the PIBSA or PIBSI utilized in the various explosive compositions or used in conjunction with PIBSA or PIBSI. In another aspect the explosive compositions are made in accordance with any one of the methods described in the immediately above US patents.

In one embodiment, PIB-PEAA compound(s) and composition(s) is/are used in explosives, downhole oil applications such as fracking. In another embodiment, the PIB-PEAA compound(s) and composition(s) or mixtures thereof is/are useful as friction modifiers in belts and the like.

In yet another embodiment, the PIB-PEAA compound(s) and composition(s) and mixtures thereof is/are useful as dispersing agents or dispersants. Non-limiting examples for uses of dispersing agents are as follows: breaking up oil into smaller droplets in water, making it easier for bacteria to metabolize, adding to coating fluids during the pigment-dispersion process to reduce the particle size of pigments and fillers, stabilizing pigments, which typically contain a pigment having an affinity for absorption to the pigment particle and a compatibilizer compatible to the resin solvent matrix, and in detergents, surface cleaners, paints and coatings, textiles, and personal care applications.

In still yet another embodiment, the PIB-PEAA compound(s) and composition(s) is/are useful in fuel additives. Currently, polyetheramines are used primarily in unmodified form as fuel additives, however, the PIB-PEAA's of the invention modified with PIB provide improved solubility in fuels and PIB-PEAA's ashless combustion would also improve performance. It is believed that the alcohol functionality of the PIB-PEAA's of the invention would result in hydrogen bonding to water in the fuel, which provides significant benefits.

In one aspect of the invention, the PIB-PEAA's compound(s) and composition(s) is/are useful as emulsion stabilizers especially since the PIB-PEAA's of the invention are amphiphilic having both hydrophilic and hydrophobic properties.

In another aspect of the invention, the PIB-PEAA compound(s) and composition(s) is/are useful as surfactants for use in cleaning, wetting, dispersing, foaming, and anti-foaming properties for use in applications such as detergents, fabric softeners, motor oils, soaps, paints, adhesives, inks, and the like.

In yet another embodiment, the PIB-PEAA compound(s) and composition(s) is/are useful in adhesive blends and reactive adhesives. In blends, it is believed that the PIB portion of the PIB-PEAA's of the invention provide adhesive properties and compatibilize polar polymers like acrylates. In reactive adhesives, it is believed that the primary and secondary amines in the PIB-PEAA's of the invention would react into the matrix in, for example, epoxy adhesives. In addition, it is believed that the PIB functionality will modify the hardness or additional tack.

In still yet another embodiment, the PIB-PEAA compound(s) and composition(s) is/are useful in lithium-ion batteries. In combination with ethylene oxide and/or propylene oxide, it is believed that the PIB-PEAA's would improve the rigidity and hydrophobicity by changing surface properties resulting in improved ionic transport and an increased specific capacity.

The invention is also directed to a method for reducing friction between contacting surfaces of a mechanical device, the method further comprising lubricating the surfaces with a lubricating composition as described above. In one aspect the above mechanical device is a spark-ignited or compression ignited internal combustion engine including the mechanical device being used in any application where lubricants are used such as in automobiles, trucks, tractors, boats, bikes, trains, windmills, planes and even lawn equipment.

### EXAMPLES

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Testing Analysis and Protocol

The oxirane value of the polyisobutylene epoxides (PIB epoxides or PIBEP) was determined using ASTM Test Method D 1652. Quantitative determination of the polyisobutylene polyetheramine was based on the stoichiometry of the reagents used in combination with both 1H and ¹³C NMR. By means of ¹H NMR, the amount of unreacted polyisobutylene epoxide was determined in addition to any additional “free” unsubstituted PIB moieties. This method also quantifies the rearrangement of the polyisobutylene epoxide to the polyisobutylene vinylic alcohol with no reaction with the polyetheramine. The presence of any unreacted primary polyetheramine can be determined by ¹³C NMR peaks assigned to the CH group and nearest CH₃ group adjacent to the primary polyetheramine. Any unreacted primary polyetheramines may indicate the presence of either a mono-polyisobutylene polyetheramine or amines that have not participated within the reaction.

Products were characterized by ¹H NMR and ¹³C NMR as follows: NMR spectra were recorded on a Bruker 600 MHz Neo Digital NMR Spectrometer at ambient temperature. All chemical shifts were referenced to tetramethylsilane (TMS) as external standard and referenced to the residual proton and carbon signals of CDCl₃ solvent at δ_{H} 7.24 ppm and δ_{C} 77.0 ppm, respectively. Samples were prepared with 60-100 mg in 0.5 mL of CDCl₃ (Sigma Aldrich). Spectra were analyzed by Fourier transform, with phase and baseline corrected by Bruker TopSpin (version 4.0.7) automated routines. Manual integration and selected peak normalization of the integrals by desired peak was applied to all spectra. The integration regions were spread over a range of at least 25 times of the line width (Hz) of the peak in both directions, and the data derived from the peak integration was taken as an average of three separate manual measurements to minimize experimental uncertainty.

### Example 1

Polyisobutylene epoxide (PIBEP) was synthesized from PIB 545 available from the TPC Group, Houston Texas. In a 300 ml stainless steel stirred pressure vessel, 100 g of the polyisobutylene epoxide (PIBEP) having a number average molecular weight Mn of 450 and an oxirane oxygen value of 1.88% is mixed with 0.113 moles of Jeffamine D-400 (Huntsman, The Woodlands, TX) at a mole ratio of 1:1 (polyetheramine:PIBEP), 0.71 g of 14% boron trifluoride in methanol, and 26.3 g of toluene and heated to 220° C. under a nitrogen atmosphere for 24 hours. The reaction pressure began at atmospheric pressure, and as the reaction was heated, autogenous pressure resulted. The toluene was removed from the product by vacuum.

There was a near complete conversion of the PIBEP (no epoxide detected in the ¹H NMR), however, PIBEP is the limiting reagent to the reaction. Approximately 45% of the primary amine was unreacted and the reaction produced a predominately mono-polyisobutylene polyether alcohol amine product as illustrated by the presence of CH and CH₃ (adjacent to the primary amine) peaks at 46.8/46.5 and 19.7 ppm, respectively, in the ¹³C NMR. The Mn of the mono-polyisobutylene polyether alcohol amine product was found to be 1028 based on a polystyrene standard.

### Example 2

Example 1 above was reproduced with the following exceptions: 14% boron trifluoride in methanol was not used. Temperature was raised and maintained throughout the reaction at 220° C. The final mono-polyisobutylene polyetheramine product obtained having an Mn of 944 based on a polystyrene standard.

In a 300 ml stainless steel stirred pressure vessel, 100 g of polyisobutylene epoxide (PIBEP) having a number average molecular weight Mn of 450 and an oxirane oxygen value of 1.88% is mixed with 0.113 moles of Jeffamine D-400 at a mole ratio of 1:1 (polyetheramine:PIBEP), and 26.2 g of toluene. The reactants were heated to 220° C. under a nitrogen atmosphere for 24 hours. The toluene was removed from the product by vacuum.

There was a near complete conversion of the PIBEP (no epoxide detected in the ¹H NMR), however PIBEP is the limiting reagent to the reaction. Approximately 45% of the primary amine was unreacted and the reaction produced a predominately mono-polyisobutylene polyetheramine product as illustrated by the presence of CH and CH₃ (adjacent to the primary amine) peaks at 46.8/46.5 and 19.7 ppm, respectively, in the ¹³C NMR. Mn of the mono-polyisobutylene polyetheramine product was found to be 944 based on a polystyrene standard.

### Example 3

Example 1 was reproduced with the following exceptions: mass grams of polyetheramine=24.99 g, PIBEP=100 g. Temperature was raised and maintained throughout the reaction at 220° C. The catalyst employed was 0.71 g of 14% boron trifluoride in methanol. 22.2 g toluene was employed as diluent. The polyetheramine:PIBEP mole ratio was 0.48:1, with final bis-polyisobutylene polyetheramine product, obtained having an Mn 1087 based on a polystyrene standard.

In a 300 ml stainless steel stirred pressure vessel, 100 g of polyisobutylene epoxide (PIBEP) having a number average molecular weight Mn of 450 and an oxirane oxygen value of 1.88% is mixed with 0.058 moles of Jeffamine D-400 at a mole ratio of 0.48:1 (polyetheramine:PIBEP), 0.71 g of 14% boron trifluoride catalyst in methanol, and 22.2 g of toluene. The reactants were heated to 220° C. under a nitrogen atmosphere for 24 hours. The toluene was removed from the product by vacuum.

The polyetheramine is the limiting reagent to the reaction this time with a slight excess of PIBEP. Toluene was added to reduce the viscosity of the reaction mixture to facilitate the reaction. The reaction produced a predominately bis-polyisobutylene polyetheramine product, as illustrated by the absence of CH and CH₃ (adjacent to the primary amine) peaks at 46.8/46.5 and 19.7 ppm, respectively, in the ¹³C NMR. Mn of the bis-polyisobutylene polyetheramine product was found to be 1087 based on a polystyrene standard.

### Example 4

Example 1 was reproduced with the following exceptions: Jeffamine ED-600 polyether-diamine based on a predominantly polyethylene oxide backbone with a mass gram of polyetheramine=67.60 g, PIBEP=100 g. Temperature was raised and maintained throughout the reaction at 220° C. The catalyst employed was 0.71 g of 14% boron trifluoride in methanol. 29.7 g toluene was employed as diluent. The polyetheramine:PIBEP mole ratio was 1:1, with final mono-polyisobutylene polyetheramine product, obtained having an Mn 1150 based on a polystyrene standard.

In a 300 ml stainless steel stirred pressure vessel, 100 g of polyisobutylene epoxide (PIBEP) having a number average molecular weight Mn of 450 and an oxirane oxygen value of 1.88% is mixed with 0.113 moles of Jeffamine ED-600 at a mole ratio of 1:1 (polyetheramine:PIBEP), 0.71 g of 14% boron trifluoride catalyst in methanol, and 29.7 g of toluene. The reactants were heated to 220° C. under a nitrogen atmosphere for 24 hours. The toluene was removed from the product by vacuum.

There was a near complete conversion of the PIBEP (no epoxide detected in the ¹H NMR), however PIBEP is the limiting reagent to the reaction. Approximately 45% of the primary amine was unreacted and the reaction produced a predominately mono-polyisobutylene polyetheramine product as illustrated by the presence of CH and CH₃ (adjacent to the primary amine) peaks at 46.8/46.5 and 19.7 ppm, respectively, in the ¹³C NMR. Mn of the mono-polyisobutylene polyetheramine product was found to be 1150 based on a polystyrene standard.

### Examples 5 and 6

Example 4 was reproduced with the following exceptions: mass grams of polyetheramine=32.45 g, PIBEP=100 g. Temperature was raised and maintained throughout the reaction at 220° C. The catalyst employed was 0.71 g of 14% boron trifluoride in methanol. 23.8 g toluene was employed as diluent. The polyetheramine:PIBEP mole ratio was 0.48:1, with final bis-polyisobutylene polyetheramine product, obtained having an Mn 1139 and 1103 based on a polystyrene standard for Examples 5 and 6, respectively.

In a 300 ml stainless steel stirred pressure vessel, 100 g of polyisobutylene epoxide (PIBEP) having a number average molecular weight Mn of 450 and an oxirane oxygen value of 1.88% is mixed with 0.058 moles of Jeffamine ED-600 at a mole ratio of 0.48:1 (polyetheramine:PIBEP), 0.71 g of 14% boron trifluoride catalyst in methanol, and 23.8 g of toluene. The reactants were heated to 220° C. under a nitrogen atmosphere for 24 hours. The toluene was removed from the product by vacuum.

The polyetheramine is the limiting reagent to the reaction this time with a slight excess of PIBEP. Toluene was added to reduce the viscosity of the reaction mixture to facilitate the reaction. The reaction produced a predominately bis-polyisobutylene polyetheramine product, as illustrated by the absence of CH and CH₃ (adjacent to the primary amine) peaks at 46.8/46.5 and 19.7 ppm, respectively, in the ¹³C NMR. Mn of the bis-polyisobutylene polyetheramine product was found to be 1139 and 1103 based on a polystyrene standard for Examples 5 and 6, respectively.

### Example 7

Example 3 was reproduced with the following exceptions: 100 g of polyisobutylene epoxide (PIBEP) originating from PIB 595 as obtained from the TPC Group, Houston TX having a number average molecular weight Mn of 950 and an oxirane oxygen value of 0.88%, mass grams of polyetheramine=11.35 g. Temperature was raised and maintained throughout the reaction at 220° C. The catalyst employed was 0.71 g of 14% boron trifluoride in methanol. 37.5 g toluene was employed as diluent. The polyetheramine:PIBEP mole ratio was 0.48:1, with final bis-polyisobutylene polyetheramine product, obtained having an Mn 1930 based on a polystyrene standard.

In a 300 ml stainless steel stirred pressure vessel, 100 g of polyisobutylene epoxide (PIBEP) having a number average molecular weight Mn of 950 and an oxirane oxygen value of 0.88% is mixed with 0.058 moles of Jeffamine D-400 at a mole ratio of 0.48:1 (polyetheramine:PIBEP), 0.71 g of 14% boron trifluoride catalyst in methanol, and 37.5 g of toluene. The reactants were heated to 220° C. under a nitrogen atmosphere for 24 hours. The toluene was removed from the product by vacuum.

The polyetheramine is the limiting reagent to the reaction this time with a slight excess of PIBEP. Toluene was added to reduce the viscosity of the reaction mixture to facilitate the reaction. The reaction produced a predominately bis-polyisobutylene polyetheramine product, as illustrated by the absence of CH and CH₃ (adjacent to the primary amine) peaks at 46.8/46.5 and 19.7 ppm, respectively, in the ¹³C NMR. Mn of the bis-polyisobutylene polyetheramine product was found to be 1930 based on a polystyrene standard.

### Example 8

Example 3 was reproduced with the following exceptions: 100 g of polyisobutylene epoxide (PIBEP) originating from PIB 5230 as obtained from the TPC Group, Houston TX having a number average molecular weight Mn of 2300 and an oxirane oxygen value of 0.40%, mass grams of polyetheramine=5.31 g. Temperature was raised and maintained throughout the reaction at 220° C. The catalyst employed was 0.71 g of 14% boron trifluoride in methanol. 70.7 g toluene was employed as diluent. The polyetheramine:PIBEP mole ratio was 0.48:1, with final bis-polyisobutylene polyetheramine product, obtained having an Mn 3997 based on a polystyrene standard.

In a 300 ml stainless steel stirred pressure vessel, 100 g of polyisobutylene epoxide (PIBEP) having a number average molecular weight Mn of 2300 and an oxirane oxygen value of 0.40% is mixed with 0.058 moles of Jeffamine D-400 at a mole ratio of 0.48:1 (polyetheramine:PIBEP), 0.71 g of 14% boron trifluoride catalyst in methanol, and 70.7 g of toluene. The reactants were heated to 220° C. under a nitrogen atmosphere for 24 hours. The toluene was removed from the product by vacuum.

The polyetheramine is the limiting reagent to the reaction this time with a slight excess of PIBEP. Toluene was added to reduce the viscosity of the reaction mixture to facilitate the reaction. The reaction produced a predominately bis-polyisobutylene polyetheramine product, as illustrated by the absence of CH and CH₃ (adjacent to the primary amine) peaks at 46.8/46.5 and 19.7 ppm, respectively, in the ¹³C NMR. Mn of the bis-polyisobutylene polyetheramine product was found to be 3997 based on a polystyrene standard.

### Example 9

Example 1 was reproduced with the following exceptions: Jeffamine T-403 polyoxypropylene triamine, a trifunctional primary amine with a mass gram of polyetheramine=41.75 g, PIBEP=80 g. Temperature was raised and maintained throughout the reaction at 220° C. The catalyst employed was 0.71 g of 14% boron trifluoride in methanol. 40.8 g toluene was employed as diluent. The polyetheramine:PIBEP mole ratio was 1:1, with final mono-polyisobutylene polyetheramine product, obtained having an Mn 863 based on a polystyrene standard.

In a 300 ml stainless steel stirred pressure vessel, 80 g of polyisobutylene epoxide (PIBEP) having a number average molecular weight Mn of 450 and an oxirane oxygen value of 1.88% is mixed with 0.095 moles of Jeffamine T-403 at a mole ratio of 1:1 (polyetheramine:PIBEP), 0.71 g of 14% boron trifluoride catalyst in methanol, and 40.8 g of toluene. The reactants were heated to 220° C. under a nitrogen atmosphere for 24 hours. The toluene was removed from the product by vacuum.

There was a near complete conversion of the PIBEP (no epoxide detected in the ¹H NMR), however PIBEP is the limiting reagent to the reaction. Approximately 60% of the primary amine was unreacted and the reaction produced a predominately mono-polyisobutylene polyetheramine product as illustrated by the presence of CH and CH₃ (adjacent to the primary amine) peaks at 46.9/46.4 and 19.7 ppm, respectively, in the ¹³C NMR. Mn of the mono-polyisobutylene polyetheramine product was found to be 863 based on a polystyrene standard.

### Example 10

Example 9 was reproduced with the following exceptions: mass grams of polyetheramine=16.7 g, PIBEP=100 g. Temperature was raised and maintained throughout the reaction at 220° C. The catalyst employed was 0.71 g of 14% boron trifluoride in methanol. 63.5 g toluene was employed as diluent. The polyetheramine:PIBEP mole ratio was 0.32:1, with final tris-polyisobutylene polyetheramine product, obtained having an Mn 1121 based on a polystyrene standard.

In a 300 ml stainless steel stirred pressure vessel, 100 g of polyisobutylene epoxide (PIBEP) having a number average molecular weight Mn of 450 and an oxirane oxygen value of 1.88% is mixed with 0.058 moles of Jeffamine T-403 at a mole ratio of 0.48:1 (polyetheramine:PIBEP), 0.71 g of 14% boron trifluoride catalyst in methanol, and 40.8 g of toluene. The reactants were heated to 220° C. under a nitrogen atmosphere for 24 hours. The toluene was removed from the product by vacuum.

The polyetheramine is the limiting reagent to the reaction this time with a slight excess of PIBEP. Toluene was added to reduce the viscosity of the reaction mixture to facilitate the reaction. The reaction produced a predominately tris-polyisobutylene polyetheramine product, as illustrated by the absence of CH and CH₃ (adjacent to the primary amine) peaks at 46.9/46.4 and 19.7 ppm, respectively, in the ¹³C NMR. Mn of the tris-polyisobutylene polyetheramine product was found to be 1121 based on a polystyrene standard.

TABLE 1

| | | | | Kinematic | | |
|---|---|---|---|---|---|---|
| | Polyetheramines | Amine:PIB | Density, | Viscosity @ | | |
| | Type | mol ratio | g/cm³ | 100° C. | Mn | Yield |
| 450 Mn PIB Epoxide | | | | | | |
| Reactions | | | | | | |
| 450 Mn PIB Epoxide | | | | 15.4 | 507 | |
| Example 1 | Jeffamine D400 | 1.00 | 0.873 | 29.3 | 1028 | 92.3% |
| Example 2 | Jeffamine D400 | 1.00 | 0.874 | 25.9 | 944 | 96.0% |
| Example 3 | Jeffamine D400 | 0.48 | 0.867 | 51.9 | 1087 | 95.0% |
| Example 4 | Jeffamine ED- | 1.00 | 0.902 | 32.8 | 1150 | 96.1% |
| | 600 | | | | | |
| Example 5 | Jeffamine ED- | 0.48 | 0.884 | 56.3 | 1139 | 93.9% |
| | 600 | | | | | |
| Example 6 | Jeffamine ED- | 0.48 | 0.901 | 54.7 | 1103 | 95.3% |
| | 600 | | | | | |
| Example 9 | Jeffamine T-403 | 1.00 | 0.879 | 43.1 | 863 | 97.3% |
| Example 10 | Jeffamine T-403 | 0.32 | 0.875 | 61.5 | 1121 | 95.5% |
| 950 Mn PIB Epoxide | | | | | | |
| Reactions | | | | | | |
| 950 Mn PIB Epoxide | | | | 186 | 977 | |
| Example 7 | Jeffamine D400 | 0.48 | 0.866 | 289 | 1930 | 94.7% |
| 2300 Mn PIB | | | | | | |
| Epoxide Reactions | | | | | | |
| 2300 Mn PIB | | | | 1646 | 2290 | |
| Epoxide | | | | | | |
| Example 8 | Jeffamine D400 | 0.48 | 0.878 | 2931 | 3997 | 96.4% |

Thus, Table 1 shows that the compositions of the invention, mPIB-PEAA, bPIB-PEAA and tPIB-PEAA are produced by the process of the invention using preferred mole ratios of polyetheramine to polyisobutylene epoxides (amine:PIB mole ratio) in high yields resulting in compositions and compounds with a diverse range of viscosities and molecular weight.

The present invention has been described herein with reference to a particular embodiment for a particular application. Although selected embodiments have been illustrated and described in detail, it may be understood that various substitutions and alterations are possible. It is possible that the process could be extended to other chemistries such as direct reaction of polyisobutylene epoxide with an alcohol or polyol, such as polyethylene oxide. Those having ordinary skill in the art and access to the present teachings may recognize additional various substitutions and alterations are also possible without departing from the spirit and scope of the present invention, and as defined by the following embodiments.

What is claimed is:

1. A polyisobutylene polyether alcohol amine compound.

2. A mono-polyisobutylene polyether alcohol amine compound.

3. A bis-polyisobutylene polyether alcohol amine compound.

4. A tris-polyisobutylene polyether alcohol amine compound.

5. A tetrakis-polyisobutylene polyether alcohol amine compound.

6. A mono-polyisobutylene polyether alcohol amine compound represented by the following general Formula (1): 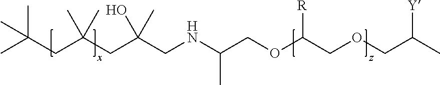
wherein x is an integer from 1 to about 200, R is H or alkyl group having 1 to carbon atoms, and z is an integer from 1 to about 100, and Y′ is an alkyl group having from 1 to 10 carbon atoms or an amino group.

7. The mono-polyisobutylene polyether alcohol amine compound of claim 6 wherein x is an integer from 1 to about 100, R is CH₃, and z is an integer from 2 to about 50, and Y′ is an amino group (—NH₂).

8. The mono-polyisobutylene polyether alcohol amine compound of claim 6 wherein x is an integer from 75 to 125 and z is an integer from 2 to 35, and Y′ is an amino group (—NH₂).

9. The mono-polyisobutylene polyether alcohol amine compound of claim 6 wherein x is 100 and z is an integer from 2 to 10, and Y′ is an amino group (—NH₂).

10. The mono-polyisobutylene polyether alcohol amine compound of claim 6 wherein x is an integer from 35 to 75, z is an integer from 2 to 10, and Y′ is an amino group (—NH₂).

11. The mono-polyisobutylene polyether alcohol amine compound of claim 6 wherein x is 50, z is an integer from 2 to 10, and Y′ is an amino group (—NH₂).

12. The mono-polyisobutylene polyether alcohol amine compound of claim 6 wherein x is an integer from 90 to 110, z is an integer from 2 to 10, and Y′ is an amino group (—NH₂).

13. The mono-polyisobutylene polyether alcohol amine compound of claim 6 wherein x is an integer from 40 to 60, z is an integer from 2 to 10, and Y′ is an amino group (—NH₂).

14. A bis-polyisobutylene polyether alcohol amine compound represented by the following general Formula (4): 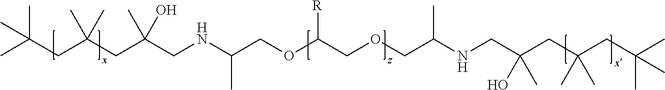
wherein x or x′ are the same or different and are integers independently from 1 to about 200, R is an alkyl group having from 1 to 10 carbon atoms, and z is an integer from 1 to 100.

15. The bis-polyisobutylene polyether alcohol amine compound of claim 14 wherein x or x′ are the same integer from 1 to about 100, R is an alkyl group having from 1 to 10 carbon atoms, and z is an integer from 2 to about 50.

16. The bis-polyisobutylene polyether alcohol amine compound of claim 14 wherein x or x′ are the same or different and are integers independently from 75 to about 125, R is an alkyl group having from 1 to 10 carbon atoms, and z is an integer from 2 to about 35.

17. The bis-polyisobutylene polyether alcohol amine compound of claim 14 wherein x or x′ is 50, R is CH₃, and z is an integer from 2 to about 10.

18. The bis-polyisobutylene polyether alcohol amine compound of claim 14 wherein x or x′ are the same or different and are integers independently from 90 to about 110, R is an alkyl group having from 1 to 10 carbon atoms, and z is an integer from 2 to about 35.

19. The bis-polyisobutylene polyether alcohol amine compound of claim 14 wherein x or x′ are the same or different and are integers independently from to about 60, R is an alkyl group having from 1 to 10 carbon atoms, and z is an integer from 2 to about 10.

20. A tris-polyisobutylene polyether alcohol amine compound represented by the following general Formula (7): 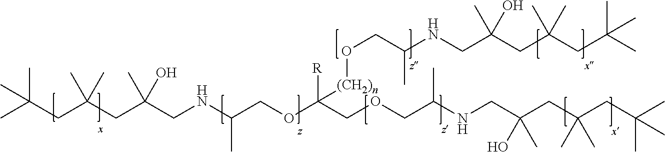
wherein x, x′ and x″ are the same or different and are integers independently from 1 to 200, R is H or an alkyl group having from 1 to 10 carbon atoms, and z, z′ and z″ are the same or different and are integers independently from 5 to 100.

21. The tris-polyisobutylene polyether alcohol amine compound of claim 20 wherein z, z′ and z″ are the same or different and are integers independently in the range from 5 to 6, to 100.

22. The tris-polyisobutylene polyether alcohol amine compound of claim 20 wherein z, z′ and z″ are the same or different and are integers independently in the range from 5 to 6, to 85.

23. A polyisobutylene polyether alcohol amine compound produced by the process comprising the steps of: (i) mixing in a reactor vessel a polyisobutylene epoxide with a hydrophilic polyetheramine in a mole ratio of about 1:1 or less, (ii) optionally introducing to the reactor vessel a protic solvent with or without a catalyst, (iii) adding a diluent to the reactor vessel, (iv) heating the reactor vessel under pressure for a period of time, (v) removing the diluent, or diluent and protic solvent and (vi) recovering the polyisobutylene polyether alcohol amine compound, wherein the hydrophilic polyetheramine is selected from the group consisting of one or more of a polyether monoamine, a polyether diamine, a polyether triamine, and a polyether tetraamine.

24. The polyisobutylene polyether alcohol amine compound produced by the process of claim 23 wherein the mole ratio of polyetheramine to polyisobutylene epoxide is in the range of from less than 1:1 to about 0.2:1.

25. The polyisobutylene polyether alcohol amine compound produced by the process of claim 23, wherein the polyisobutylene epoxide comprises one or more of the respective Formulas 10, 11 and 12: 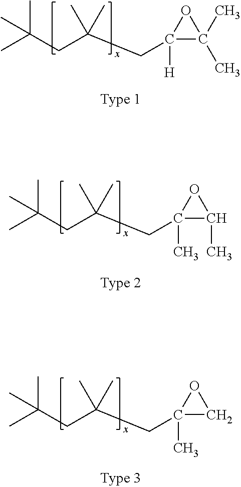
wherein x is an integer from 1 to about 200.

26. The polyisobutylene polyether alcohol amine compound produced by the process of claim 23, wherein the polyisobutylene epoxide is a Type 3 polyisobutylene epoxide.

27. The polyisobutylene polyether alcohol amine compound produced by the process of claim 23, wherein the number average molecular weight (Mn) of the polyisobutylene epoxide is in the range of from 150 to 3000.

28. The polyisobutylene polyether alcohol amine compound produced by the process of claim 23, wherein the oxirane value of the polyisobutylene epoxide is in the range of from 2% to 0.15%.

29. The polyisobutylene polyether alcohol amine compound produced by the process of claim 23, wherein reactor vessel is heated to a temperature in the range of from about 60° C. to about 260° C.

30. The polyisobutylene polyether alcohol amine compound produced by the process of claim 23, wherein the compound has a number average molecular weight in the range of from 170 to 2700.

31. The polyisobutylene polyether alcohol amine compound produced by the process of claim 23, wherein the process results in: (i) 5 mol % to 98 mol % of the polyisobutylene polyether alcohol amine compound, (ii) up to 10 mol % of unreacted hydrophilic polyetheramine, and (iii) up to 5 mol % of the unreacted polyisobutylene epoxide, wherein the sum of the mol % of i, ii and iii together add to between 98 mol % and 100 mol %.

32. The polyisobutylene polyether alcohol amine compound produced by the process of claim 23, wherein the compound is a mono-polyisobutylene polyether alcohol amine compound.

33. The polyisobutylene polyether alcohol amine compound produced by the process of claim 23, wherein the compound is a bis-polyisobutylene polyether alcohol amine compound.

34. The polyisobutylene polyether alcohol amine compound produced by the process of claim 23, wherein the compound is a tris-polyisobutylene polyether alcohol amine compound.

35. The polyisobutylene polyether alcohol amine compound produced by the process of claim 23, wherein the compound is a tetra-polyisobutylene polyether alcohol amine compound.

36. The polyisobutylene polyether alcohol amine compound produced by the process of claim 23, wherein a polyisobutylene polyether alcohol amine composition comprising two or more a mono-polyisobutylene polyether alcohol amine compound, a bis-polyisobutylene polyether alcohol amine compound, a tris-polyisobutylene polyether alcohol amine compound and a tetra-polyisobutylene polyether alcohol amine compound.

37. The polyisobutylene polyether alcohol amine compound produced by the process of claim 23, wherein the polyisobutylene polyether alcohol amine composition having an Mn in the range of from 800 to 6000, a PDI in the range of from 1.2 to 3, and a viscosity in the range of from 25 cSt to 5000 cSt.

38. A process for making a polyisobutylene polyether alcohol amine compound, the process comprising the steps of: (i) mixing in a reactor vessel a polyisobutylene epoxide with a hydrophilic polyetheramine in a mole ratio of about 1:1 or less, (ii) optionally introducing to the reactor vessel a protic solvent with or without a catalyst, (iii) adding a diluent, (iv) heating the reactor vessel under pressure for a period of time, (v) removing the diluent or the diluent and protic solvent, and (vi) recovering the polyisobutylene polyether alcohol amine compound, wherein the hydrophilic polyetheramine is selected from the group consisting of one or more of a polyether monoamine, a polyether diamine, a polyether triamine, and a polyether tetraamine.

39. The process of claim 38, wherein the mole ratio of polyetheramines to polyisobutylene epoxide is in the range of from less than 1:1 to about 0.2:1.

40. The process of claim 38, where the polyisobutylene epoxide comprises one or more of the respective Formulas 10, 11 and 12: 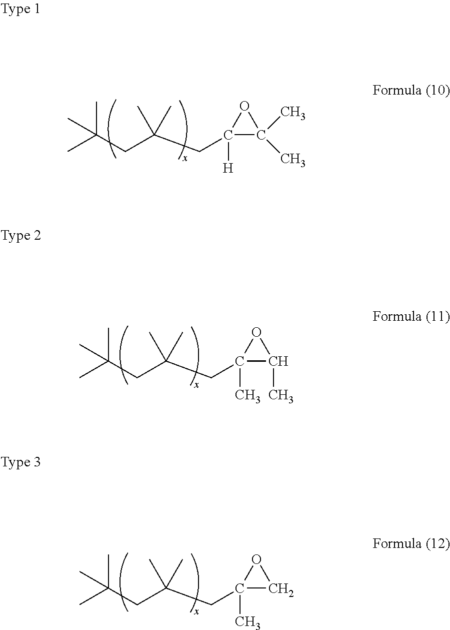
wherein x is an integer from 1 to about 200.

41. The process of claim 38, wherein the polyisobutylene epoxide is predominantly Type 3.

42. The process of claim 38 wherein the polyisobutylene epoxide comprises an Mn of from 150 to 5000 and an oxirane oxygen value of 2% to 0.15%.

43. The process of claim 38 wherein the polyisobutylene epoxide comprises an Mn of from 400 to 3000 and an oxirane oxygen value of 2% to 0.25%.

44. The process of claim 38 wherein the polyisobutylene epoxide comprises an epoxidated highly reactive polyisobutylene having between 60 mol % to 90 mol % alpha-vinylidene isobutylene isomer content.

45. The polyisobutylene polyether alcohol amine produced by the process of claim 21, wherein the polyisobutylene amine alcohol compound is used in, or as, a lubricating composition, adhesive composition, a sealant composition, a grease composition, an emulsifier composition, paint composition, a coating composition, a polymer composition, or a resin composition.

46. A process for making a polyisobutylene polyether alcohol amine by reacting a hydrophilic polyetheramine with a polyisobutylene epoxide in mole ratio of hydrophilic polyetheramine to polyisobutylene epoxide of about 1:1, wherein the hydrophilic polyetheramine is a product produced by alkoxylating a mono-, di-, tri-, tetra- or multifunctional alcohol or alkyl phenol with an alkylene oxide to form an alkylene oxide adduct, and then catalytically aminating the alkylene oxide adduct in the presence of hydrogen and ammonia to form the polyetheramine.

47. The process of claim 46 wherein the alkylene oxide is selected from one or more of the group consisting of ethylene oxide, propylene oxide, or butylene oxide.

48. The process of claim 46 wherein the polyisobutylene polyether alcohol amine is a mono-polyisobutylene polyether alcohol amine.

49. The process of claim 46 wherein the polyisobutylene polyether alcohol amine is a bis-polyisobutylene polyether alcohol amine.

50. The process of claim 46 wherein the polyisobutylene polyether alcohol amine is a tris-polyisobutylene polyether alcohol amine.
